(19) United States
(12) Patent Application Publication
(10) Pub. No.: US 2010/0104900 A1
(43) Pub. Date: Apr. 29, 2010

(54) FUEL CELL POWER GENERATION SYSTEM

(76) Inventors: Hiroshi Kashino, Osaka (JP); Norihisa Yoshimoto, Osaka (JP); Kohei Ugawa, Osaka (JP); Shoji Saibara, Osaka (JP)

Correspondence Address: BIRCH STEWART KOLASCH & BIRCH, PO BOX 747, FALLS CHURCH, VA, 22040-0747, US

(21) Appl. No.: 12/529,965

(22) PCT Filed: Mar. 14, 2008
(86) PCT No.: PCT/JP2008/054736

§ 371 Date: Sep. 4, 2009

(30) Foreign Application Priority Data
Mar. 16, 2007 (JP) 2007-068276
Jun. 4, 2007 (JP) 2007-147649
Jul. 17, 2007 (JP) 2007-185209

(51) Int. Cl. H01M 8/06; H01M 8/10

(52) U.S. Cl. 429/19; 429/27; 429/30

(57) ABSTRACT

The present invention provides a fuel cell power generation system that includes: a fuel cell including a first membrane electrode assembly including a positive electrode for reducing oxygen, a negative electrode for oxidizing hydrogen, and a solid electrolyte membrane disposed between the positive electrode and the negative electrode; and a fuel channel for supplying hydrogen to the fuel cell. The fuel cell includes a plurality of the first membrane electrode assemblies, and a hydrogen eliminating apparatus capable of eliminating at least part of the hydrogen that is present in the system is connected to the fuel channel.

### TECHNICAL FIELD

The present invention relates to fuel cell power generation systems with a long life.

### BACKGROUND ART

With the recent widespread use of cordless devices such as a personal computer and a mobile telephone, batteries used as a power source of the cordless devices axe increasingly required to have a smaller size and higher capacity. At present, a lithium ion secondary battery that can achieve a small size, light weight, and high energy density is being put to practical use and growing in demand as a portable power source. However, depending on the types of cordless devices to be used, the lithium ion secondary battery is not yet reliable enough to ensure a continuous available time.

To solve this problem, for example, fuel cells such as a polymer electrolyte fuel cell (PEFC) are being developed. The fuel cells can be used continuously as long as fuel and oxygen are supplied. The PEFC, which includes membrane electrode assemblies (MEAs) each including a positive electrode, a negative electrode, and a solid polymer electrolyte as an electrolyte and uses oxygen in the air as a positive active material and hydrogen as a negative active material, has attracted considerable attention because it is a battery that can have a higher energy density than the lithium ion secondary battery.

In the current fuel cell, however, growth of catalyst particles and oxidization of a carbon powder for carrying the catalyst particles occur in the positive electrode and the negative electrode due to hydrogen that remains in the fuel cell even after an operation of the fuel cell is stopped. As a result, the positive electrode and the negative electrode deteriorate when the fuel cell is used for a long period of time. Therefore, extension of the life of the electrodes has been regarded as the issue to be addressed. Although the mechanism of how the positive electrode and the negative electrode deteriorate is not clear, it has been assumed that the growth of the catalyst particles and the oxidization of the carbon powder occur in the positive electrode because an open circuit voltage of each MEA reaches nearly 1 V due to the hydrogen that remains in the cell, and the growth of the catalyst particles and the oxidization of the carbon powder occur in the negative electrode in the same manner as in the positive electrode due to the occurrence of burning reaction between the hydrogen and oxygen that leaked in the negative electrode.

Studies also have been conducted on methods for preventing the deterioration of the positive electrode and the negative electrode due to the hydrogen that remains in the fuel cell as described above. For example, Patent documents 1 and 2 propose that, in a fuel cell power generation system that uses hydrogen as fuel, in order to consume residual hydrogen after the system is stopped, an external resistance is connected to each MEA included in the fuel cell so as to perform an electrical discharge using the residual hydrogen.

Furthermore, Patent document 3 proposes to dispose, in addition to an output fuel cell, a processing fuel cell for consuming residual hydrogen let out from the output fuel cell at a gas outlet.

The techniques disclosed in Patent documents 1 to 3 are not, however, for preventing a flow of surplus hydrogen into a fuel cell. As Patent document 4 describes, for example, in a case where hydrogen is supplied by using a chemical reaction between a hydrogen generating material and water, it is difficult to completely stop a supply of hydrogen from a hydrogen source at the same time when an operation of the fuel cell is stopped, i.e., at the same time when a power supply to an external load from the fuel cell is stopped. Thus, the MEAs need to be operated for a long period of time to consume the surplus hydrogen. In such a case, the deterioration of the electrodes advances gradually due to the continuation of the power generation. Further, in the fuel cell, an MEA located on the upstream side of a hydrogen gas flow, in other words, an MEA located closer to a hydrogen gas supply source is exposed to a larger amount of the hydrogen gas than an MEA located on the downstream side or located closer to a hydrogen gas outlet, so that it is likely to deteriorate. Particularly, when using the hydrogen source as described in Patent document 4, there is a possibility that a large amount of the surplus hydrogen flows into the fuel cell. Thus, in order to prevent a variation in properties among the MEAs, it is necessary to prevent the surplus hydrogen from flowing into the fuel cell.

Patent document 1: JP H11-26003 A
Patent document 2: JP 2003-115305 A
Patent document 3: JP 2007-80721 A
Patent document 4: pamphlet of WO2006/073113

### DISCLOSURE OF INVENTION

The present invention is a fuel cell power generation system that includes: a fuel cell including a first membrane electrode assembly including a positive electrode for reducing oxygen, a negative electrode for oxidizing hydrogen, and a solid electrolyte membrane disposed between this positive electrode and the negative electrode, and a fuel channel for supplying hydrogen to the fuel cell. The fuel cell includes a plurality of the first membrane electrode assemblies, and a hydrogen eliminating apparatus capable of eliminating at least part of the hydrogen that is present in the system is connected to the fuel channel.

According to the present invention, it is possible to reduce an amount of surplus hydrogen that flows into the fuel cell from the hydrogen source after an operation of the fuel cell is stopped. Thus, deterioration of the fuel cell due to the surplus hydrogen can be prevented, and thereby the life of the fuel cell can be extended.

### BRIEF DESCRIPTION OF DRAWINGS

FIG. 1 is a schematic diagram showing a configuration example of a fuel cell power generation system according to Embodiment 1 of the present invention.

FIG. 2 is a schematic diagram showing another configuration example of the fuel cell power generation system according to Embodiment 1 of the present invention.

FIG. 3 is a schematic cross-sectional view showing one example of a fuel cell used in the fuel cell power generation system of the present invention.

FIG. 4 is a schematic view showing one example of a hydrogen source used in the fuel cell power generation system of the present invention.

FIG. 5 is a schematic cross-sectional view showing one example of a hydrogen eliminating apparatus used in the fuel cell power generation system of the present invention.

FIG. 6 is a schematic diagram showing a configuration example of a fuel cell power generation system according to Embodiment 2 of the present invention.

FIG. 7 is a schematic diagram showing another configuration example of the fuel cell power generation system according to Embodiment 2 of the present invention.

FIG. 8 is a schematic diagram showing yet another configuration example of the fuel cell power generation system according to Embodiment 2 of the present invention.

FIG. 9 is a schematic diagram showing yet another configuration example of the fuel cell power generation system according to Embodiment 2 of the present invention.

FIG. 10 is a schematic diagram showing yet another configuration example of the fuel cell power generation system according to Embodiment 2 of the present invention.

FIG. 11 is a schematic diagram showing a configuration example of a fuel cell power generation system according to Embodiment 3 of the present invention.

FIG. 12 is a schematic diagram showing another configuration example of the fuel cell power generation system according to Embodiment 3 of the present invention.

FIG. 13 is a schematic diagram showing yet another configuration example of the fuel cell power generation system according to Embodiment 3 of the present invention.

FIG. 14A is a plan view showing a membrane electrode assembly that constitutes a fuel cell in a fuel cell power generation system of Example 1, and FIG. 14B is a cross-sectional view of the membrane electrode assembly shown in FIG. 14A.

FIG. 15 is a plan view showing a positive electrode panel plate that constitutes the fuel cell in the fuel cell power generation system of Example 1.

FIG. 16 is a plan view showing a positive electrode end collector plate that constitutes the fuel cell in the fuel cell power generation system of Example 1.

FIG. 17 is a plan view showing a positive electrode collector plate that constitutes the fuel cell in the fuel cell power generation system of Example 1.

FIG. 18A is a plan view showing a positive electrode insulating plate that constitutes the fuel cell in the fuel cell power generation system of Example 1, and FIG. 18B is a cross-sectional view along the line I-I in FIG. 18A.

FIG. 19A is a plan view showing a fuel tank that constitutes the fuel cell in the fuel cell power generation system of Example 1, FIG. 19B is a cross-sectional view along the line II-II in FIG. 19A, and FIG. 19C is a cross-sectional view along the line III-III in FIG. 19A.

FIG. 20 is a plan view showing a sealing material that constitutes the fuel cell in the fuel cell power generation system of Example 1.

FIG. 21A is a plan view showing a membrane electrode assembly that constitutes a hydrogen eliminating apparatus in the fuel cell power generation system of Example 1, and FIG. 21B is a cross-sectional view of the membrane electrode assembly shown in FIG. 21A.

FIG. 22 is a plan view showing a positive electrode collector plate that constitutes the hydrogen eliminating apparatus in the fuel cell power generation system of Example 1.

FIG. 23A is a plan view showing a tank that constitutes the hydrogen eliminating apparatus in the fuel cell power generation system of Example 1, FIG. 23B is a cross-sectional view along the line IV-IV in FIG. 23A, and FIG. 23C is a cross-sectional view along the line V-V in FIG. 23A.

FIG. 24 is a plan view showing a sealing material that constitutes the hydrogen eliminating apparatus in the fuel cell power generation system of Example 1.

FIG. 25 is a schematic diagram showing a configuration of the fuel cell power generation system of Example 1.

FIG. 26 is a schematic diagram showing a configuration of a fuel cell power generation system of Example 5.

FIG. 27 is a graph showing a change over time in a flow velocity of gas that flows in and out of a fuel cell during a power generation test on the fuel cell power generation system of Example 5.

FIG. 28 is a graph showing a change over time in voltage of the membrane electrode assembly during the power generation test on the fuel cell power generation system of Example 5.

FIG. 29 is a graph showing a change over time in a flow velocity of gas that flows in and out of a fuel cell during a power generation test on a system that was configured similarly to the fuel cell power generation system of Example 5 except that a backflow prevention portion was not provided.

### DESCRIPTION OF THE INVENTION

Hereinafter, embodiments and examples of the present invention will be described with reference to the drawings. In FIGS. 1 to 26, the same portions or portions with the same function are denoted in principle by the same reference numerals, and the description thereof may be omitted.

### Embodiment 1

FIG. 1 is a schematic diagram showing one example of the fuel cell power generation system of the present invention. Reference numeral 1 denotes a fuel cell including a plurality of first membrane electrode assemblies (MEAs) 100 that are connected to each other electrically in series. The fuel cell 1 is connected to an external load 4, such as an electronic device to which the fuel cell power generation system of the present invention is applied. Reference numeral 2 denotes a hydrogen producing apparatus as a hydrogen source for supplying hydrogen to the fuel cell 1 as fuel. A fuel channel 6 is formed between the fuel cell 1 and the hydrogen producing apparatus 2, and a hydrogen eliminating apparatus 3 is disposed in the fuel channel 6. Reference numeral 7 denotes a stop valve. By dosing the stop valve 7 in accordance with the operation of the fuel cell 1 being stopped, a supply of hydrogen to the fuel 1 from the hydrogen producing apparatus 2 can be shut off. Further, by opening the stop valve 7 in accordance with the operation of the fuel cell 1 being started, hydrogen can be supplied to the fuel cell 1 from the hydrogen producing apparatus 2.

The hydrogen eliminating apparatus 3 is operated when the external load 4 is turned off, in other words, when a supply of power to the external load 4 from the fuel cell 1 is stopped. Thus, when a supply of hydrogen to the fuel cell 1 from the hydrogen producing apparatus 2 continues or when surplus hydrogen flows into the fuel cell 1 even after the supply of hydrogen is stopped by dosing the stop valve 7, the hydrogen that heads toward the fuel cell 1 can be eliminated by the hydrogen eliminating apparatus 3. As a result, the supply of hydrogen into the fuel cell 1 stops, or the amount thereof is significantly reduced. Further, when the hydrogen eliminating apparatus 3 is capable of eliminating a larger amount of hydrogen than the surplus hydrogen supplied from the hydrogen producing apparatus 2, not only the hydrogen from the hydrogen producing apparatus 2 but also the surplus hydrogen that remains in the fuel cell 1 can be eliminated.

The hydrogen eliminating apparatus 3 also can be operated when the fuel cell 1 is in operation. For example, when the amount of hydrogen supply exceeds the amount of hydrogen required to generate power at the fuel cell 1, the surplus hydrogen can be eliminated by operating the hydrogen eliminating apparatus 3 so as to adjust the amount of hydrogen supply to the fuel cell 1.

It is not essential that the fuel cell power generation system of the present invention is provided with the stop valve 7. However, when the stop valve 7 is provided in the fuel cell power generation system, the stop valve 7 is preferably disposed between the hydrogen producing apparatus 2 and the hydrogen eliminating apparatus 3 as shown in FIG. 1. Further, although FIG. 1 shows a configuration in which the external load 4 is connected to the fuel cell 1 through a switch ($), the external load 4 may be connected directly to the fuel cell 1.

The hydrogen producing apparatus 2 as a hydrogen source may be provided in the fuel cell power generation system of the present invention or it may be provided separately from the fuel cell power generation system of the present invention.

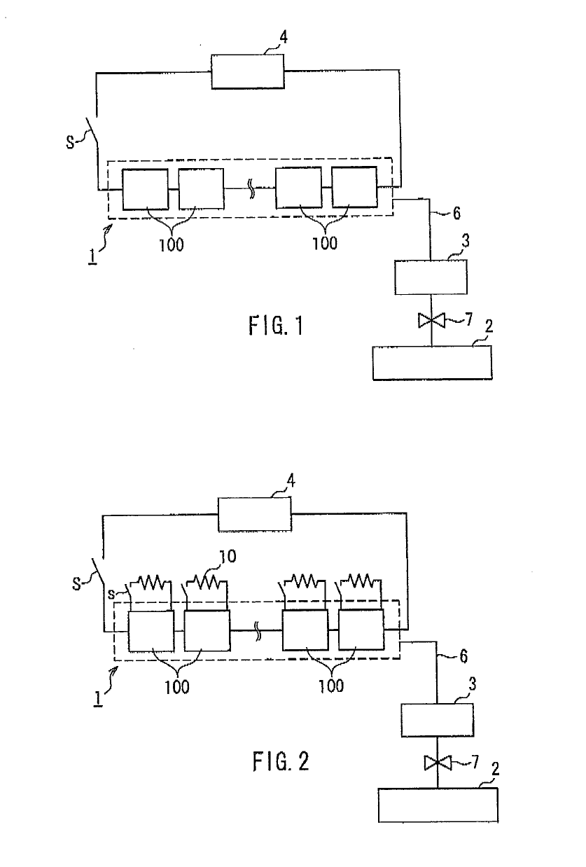

FIG. 2 is a schematic diagram showing another example of the fuel cell power generation system of the present invention. The fuel cell power generation system shown in FIG. 2 is different from the fuel cell power generation system shown in FIG. 1 in that a resistance 10 is connected to each of the individual MEAs 100 provided in the fuel cell 1 with a lead or the like. The positive electrode and the negative electrode of each MEA 100 can be brought into electric conduction through the resistance 10.

In the fuel cell power generation system shown in FIG. 2, when a supply of power to the external load 4 is ended, and the operation of the fuel cell 1 is stopped, the positive electrode and the negative electrode of each of the individual MEAs 100 are brought into conduction by turning on a switch (s) provided on the lead, which connects the positive electrode and the negative electrode. As a result, the individual MEAs 100 generate power using hydrogen that remains in the fuel cell 1 as fuel, and thus the surplus hydrogen in the fuel cell 1 can be consumed. The surplus hydrogen in the system can be consumed faster by using the hydrogen eliminating apparatus 3 in combination with the MEAs 100 in the fuel cell 1 then by using the hydrogen eliminating apparatus 3 solely to process the surplus hydrogen. Thus, the deterioration of the fuel cell 1 due to the surplus hydrogen can be further suppressed, and the life of the fuel cell 1 can be further extended. In addition, the hydrogen eliminating apparatus 3 can be downsized and simplified.

In the fuel cell power generation system shown in FIG. 2, the positive electrode and the negative electrode of each MEA 100 in the fuel cell 1 are connected to each other through the resistance 10. The resistance value of the resistance 10 may be set such that the time required for a voltage between the positive electrode and the negative electrode of each MEA 100 to drop to 0.1 V after the operation of the fuel cell 1 is stopped is within one minute, for example. Further, the positive electrode and the negative electrode of the MEAs 100 may be directly brought into conduction with a lead, instead of using the resistance 10. Further, it is not essential that all of the positive electrodes and the negative electrodes of the MEAs 100 are respectively brought into electric conduction, and the positive electrode and the negative electrode of at least one MEA 100 may be brought into electric conduction. For example, when the surplus hydrogen is processed by using one or a plurality of the MEAs 100 located on the upstream side of a hydrogen flow which is dose to the hydrogen producing apparatus 2, it is possible to prevent the surplus hydrogen from flowing into the MEA 100 located on the down stream side. The MEA 100 located on the down stream side may be used to process the surplus hydrogen. By allowing the MEA 100 located the down stream side to generate power for a longer time than the MEAs 100 disposed on the upstream side whose properties are likely to deteriorate, it is possible to let the deterioration of the properties death MEA 100 advance equally in the fuel cell 1 as a whole, so that a variation in their properties can be suppressed.

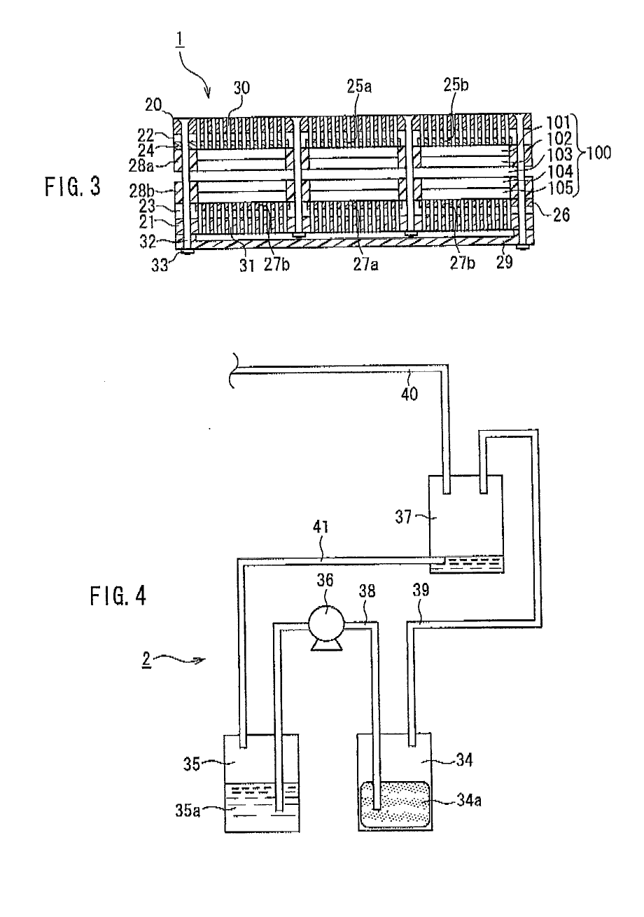

FIG. 3 is a schematic cross-sectional view showing one example of the fuel cell (fuel cell module) used in the fuel cell power generation system of the present invention. Although FIG. 3 is a cross-sectional view, hatching for indicating a cross-section is omitted for some components in order to facilitate the understanding of each component. Further, a configuration for bringing the positive electrode and the negative electrode of the MEAs into electric conduction is not shown in FIG. 3.

The fuel cell 1 shown in FIG. 3 includes the MEAs 100 each composed of a positive electrode including a positive electrode diffusion layer 101 and a positive electrode catalytic layer 102, a solid electrolyte membrane 103, and a negative electrode including a negative electrode diffusion layer 105 and a negative electrode catalytic layer 104 being stacked on top of each other in sequence. The number of the MEAs 100 included in the fuel cell 1 is three. These MEAs 100 are disposed in a plane.

On the positive electrode side of each MEA 100, positive electrode collector plates 24, 25a, and 25b, a positive electrode insulating plate 22, and a positive electrode panel plate 20 are disposed in sequence. Further, on the negative electrode side of each MEA 100, negative electrode collector plates 26, 27a, and 27b, a negative electrode insulating plate 23, and a negative electrode panel plate 21 axe disposed in sequence.

All of the MEAs 100 are integrated by being interposed between the positive electrode panel plate 20 and the negative electrode panel plate 21. Although it is not clear from FIG. 3, the adjoining MEAs 100 are connected to each other in series by the electric connection between the positive electrode collector plates 24, 25a, and 25b and the negative electrode collector plates 26, 27a, and 27b.

A plurality of oxygen inflow holes for introducing oxygen outside the fuel cell 1 into the positive electrode are formed on the positive electrode collector plates 24, 25a, and 25b, the positive electrode insulating plate 22, and the positive electrode panel plate 20. The oxygen inflow holes on the positive electrode collector, plates 24, 95a and 25b, the oxygen inflow holes on the positive electrode insulating plate 22, and the oxygen inflow holes on the positive electrode panel plate 20 constitute a plurality of positive electrode openings 30 that run from the outer surface of the positive electrode panel plate 20 to the positive electrode diffusion layer 101 of each MEA 100. Structurally, the oxygen (air) outside the fuel cell 1 is diffused through the positive electrode openings 30, and the oxygen is supplied to the positive electrode diffusion layers 101.

Further, in the fuel cell 1 shown in FIG. 3, a plurality of fuel inflow holes for introducing fuel in a fuel tank 29 into the negative electrode are formed on the negative electrode collector plates 26, 27a, and 27b, the negative electrode insulating plate 23 and the negative electrode panel plate 21. The fuel inflow holes on the negative electrode collector plates 26, 27a, and 27b, the fuel inflow holes on the negative electrode insulating plate 23 and the fuel inflow holes on the negative electrode panel plate 21 constitute a plurality of negative electrode openings 31 that run from a surface of the negative electrode panel plate 21 on the fuel tank 29 side to the negative electrode diffusion layer 105 of each MEA 100. Structurally, the fuel in the fuel tank 29 is supplied to the negative electrode diffusion layers 105 through the negative electrode openings 31.

In the fuel cell 1 shown in FIG. 3, the positive electrode panel plate 20, the negative electrode panel plate 21, and further, the fuel tank 29 are fixed with bolts 32 and nuts 33. Further, in FIG. 3, reference numerals 28a and 28b denote sealing materials.

The positive electrode diffusion layers 101 and the negative electrode diffusion layers 105 are made of a porous electron conductive material or the like, and a porous carbon sheet or the like treated to be water repellent is used, for example. A paste of a carbon powder including fluororesin particles (such as polytetrafluoroethylene (PTFE) resin particles) may be applied on the positive electrode diffusion layers 101 and the negative electrode diffusion layers 105 on the catalytic layer side for the sake of further enhancing the water repellency and improving the contact with the catalytic layers.

The positive electrode catalytic layers 102 have a function of reducing the oxygen that was diffused through the positive electrode diffusion layers 101. The positive electrode catalytic layers 102 contain, for example, a carbon powder supporting a catalyst (catalyst-supporting carbon powder) and a proton conductive material. Further, the positive electrode catalytic layers 102 may further contain a binder, such as a resin, as needed.

There is no particular limitation for the catalyst used for the positive electrode catalytic layers 102 as long as the catalyst can reduce oxygen. Examples of the catalysts include a platinum fine powder. Further, the catalyst may be a fine powder of an alloy of platinum and at least one metallic element selected from a group consisting of iron, nickel, cobalt, tin, ruthenium and gold.

A carbon black having a BET specific surface area of from 10 to 2,000 m²/g and a mean particle diameter of from 20 to 100 nm is used as the carbon powder as the carrier of the catalyst, for example. The catalyst can be supported on the carbon powder, for example, by a colloidal method.

It is preferable that the content ratio between the carbon powder and the catalyst is, for example, from 5 to 400 parts by mass of the catalyst with respect to 100 parts by mass of the carbon powder for the following reason. With such a content ratio, positive electrode catalytic layers having sufficient catalyst activity can be obtained. Furthermore, for example, in a case where the catalyst-supporting carbon powder is produced by a method of precipitating a catalyst on the carbon powder (for example, a colloidal method), as long as the content ratio between the carbon powder and the catalyst is in the range as described above, the diameter of the catalyst does not become too large, and sufficient catalyst activity can be obtained.

There is no particular limitation for the proton conductive material contained in the positive electrode catalytic layers 102, and resins having a sulfonate group, such as a polyperfluorosulfonic acid resin, a sulfonated polyethersulfone resin, and a sulfonated polyimide resin, can be used. Specifically, examples of the polyperfluorosulfonic acid resins include “Nafion” (Trade Name) produced by Dupont, “Flemion” (Trade Name) produced by Asahi Glass Co., Ltd., “Aciplex” (Trade Name) produced by Asahikasei Ind. Co., Ltd., and the like.

It is preferable that the content of the proton conductive material in the positive electrode catalytic layers 102 is from 2 to 200 parts by mass with respect to 100 parts by mass of the catalyst-supporting carbon powder for the following reason. When the proton conductive material is contained in the above amount, sufficient proton conductivity can be obtained in the positive electrode catalytic layers, and the electric resistance value does not become too large, and thus, a fuel cell with a favorable cell performance can be obtained.

There is no particular limitation for the binder used in the positive electrode catalytic layers 102, and fluororesins, such as polytetrafluoroethylene (PTFE), tetrafluoroethylene-perfluoroalkylvinylether copolymer (PFA), tetrafluoroethylene-hexafluoropropylene copolymer (FEP), tetrafluoroethylene-ethylene copolymer (E/TFE), polyvinylidenefluoride (PVDF), and polychlorotrifluoroethylene (PCTFE), non-fluorine-based resins, such as polyethylene, polypropylene, nylon, polystyrene, polyester; ionomer, butyl rubber, an ethylene-vinyl acetate copolymer, an ethylene-ethyl acrylate copolymer, and an ethylene-acrylic acid copolymer, and the like can be used.

It is preferable that the content of the binder in the positive electrode catalytic layers 102 is from 0.01 to 100 parts by mass with respect to 100 parts by mass of the catalyst-supporting carbon powder for the following reason. When the binder is contained in the above amount, the positive electrode catalytic layers can obtain sufficient binding properties, and the electric resistance value does not become too large, and thus, a fuel cell with, a favorable cell battery performance can be obtained.

The negative electrode catalytic layers 104 have a function of oxidizing fuel such as hydrogen that was diffused through the negative electrode diffusion layers 105. The negative electrode catalytic layers 104 contain, for example, a carbon powder supporting a catalyst (catalyst-supporting carbon powder) and a proton conductive material. Further, the negative electrode catalytic layers 104 may contain a binder, such as a resin, as needed.

There is no particular limitation for the catalyst used in the negative electrode catalytic layers 104 as long as the catalyst can oxidize the fuel such as hydrogen. Each of the catalysts described above as the examples that can be used in the positive electrode catalytic layers 102 also can be used as the catalyst to be used in the negative electrode catalytic layers 104, for example. The materials described, above as the examples of the carbon powder, the proton conductive material, and the binder used in the positive electrode catalytic layers 102 also can be used respectively as the carbon powder, the proton conductive material, and the binder to be used in the negative electrode catalytic layers 104.

There is no particular limitation for the solid electrolyte membrane 103 as long as it is a membrane made of a material capable of transporting a proton and having no electron conductivity. Examples of the materials of which the solid electrolyte membrane 103 can be made include polyperfluorosulfonic acid resins, specifically, “Nafion” (Trade Name) produced by Dupont, “Flemion” (Trade Name) produced by Asahi Glass Co., Ltd., “Aciplex” (Trade Name) produced by Asahikasei Ind. Co., Ltd., and the like. Alternatively, a sulfonated polyethersulfone resin, a sulfonated polyimide resin, a sulfuric acid doped polybenzimidazole, and the like also can be used as the material for the solid electrolyte membrane 103.

FIG. 4 is a schematic diagram showing one example of the hydrogen source used in the fuel cell power generation system of the present invention. The hydrogen source shown in FIG. 4 is a configuration example of a hydrogen producing apparatus having a mechanism of generating hydrogen by supplying water to a hydrogen generating material continuously or intermittently and bringing the hydrogen generating material and the water into a reaction.

A hydrogen producing apparatus 2 as a hydrogen source includes a hydrogen-generating-material containing vessel 34 for containing a hydrogen generating material 34a and a water containing vessel 35 for containing water 35a. The water 35a is supplied into the hydrogen-generating-material containing vessel 34 from the water containing vessel 35, and the hydrogen generating material 34a and the water 35a are brought into a reaction within the hydrogen-generating-material containing vessel 34 so as to produce hydrogen. Thus, the hydrogen-generating-material containing vessel 34 also plays a role as a reactor for the hydrogen generating material 34a and the water 35a. The hydrogen generated in the hydrogen-generating-material containing vessel 34 is supplied to the fuel cell, through a fuel channel composed of hydrogen outflow pipes 39 and 40.

A water supply pipe 38 used for supplying the water 35a to the hydrogen-generating-material containing vessel 34 from the water containing vessel 35 is provided with a water supply pump 36. The water 35a contained in the water containing vessel 5 may be a liquid containing at least water such as neutral water, an acid aqueous solution, or an alkali aqueous solution, and a suitable liquid may be selected on the basis of, for example, reactivity with the hydrogen generating material 34a to be used.

The hydrogen-generating-material containing vessel 34 and the water containing vessel 35 also can be made attachable to and detachable from the system. With such a configuration, when the hydrogen generating material 34a in the hydrogen-generating-material containing vessel 34 is completely consumed or the supply of the water 35a in the water containing vessel 35 becomes short, the vessels can be detached from the system and the hydrogen-generating-material containing vessel 34 filled with the hydrogen generating material 34a and the water containing vessel 35 filled with the water 35a can be newly attached to the system, and thereby hydrogen can be produced again.

Although there is no particular limitation for the hydrogen generating material 34a contained in the hydrogen-generating-material containing vessel 34, it is preferable to use a material that can generate hydrogen by reacting with water at a low temperature of 120° C. or less. For example, metals such as aluminum, silicon, zinc, and magnesium, an alloy containing 50 mass % or more, preferably 80 mass % or more, and more preferably 90 mass % or more of one or more elements selected from aluminum, silicon, zinc, and magnesium, a metal hydride, and the like can be preferably used.

The hydrogen generating material made of one of the above described metals or the alloy is stabilized by forming an oxide film on its surface. Therefore, it is preferable to set the particle diameter of the hydrogen generating material as small as possible and to increase the size of the reaction area in order to enhance its reactivity. For example, it is preferable that particles of the hydrogen generating material have a mean particle diameter of 100 μm or less and more preferably 50 μm or less. Further, it is preferable that the particles are in the form of flakes so as to enhance the reaction efficiency. It is preferable that the hydrogen generating material preferably has a particle diameter of 0.1 μm or more. This is because when the particle diameter is too small, the bulk density becomes small, and not only the packing density drops but also handing of the material becomes difficult.

For example, a laser diffraction scattering method or the like can be used to measure the mean particle diameter. According to this method, specifically, the measuring object is dispersed in a liquid phase such as water and irradiated with a laser beam to detect scattering intensity distribution, and the particle diameter distribution is measured using the scattering intensity distribution. The measuring device for the laser diffraction scattering method may be, for example, “MICROTRAC HRA” manufactured by Nikkiso Co., Ltd.

Examples of the metal hydrides that can be used as the hydrogen generating material include sodium borohydride, potassium borohydride and the like. Although these metal hydrides are relatively stable in an alkali aqueous solution, they can react quickly with water and generate hydrogen when there is a catalyst. A metal such as Pt or Ni or acid can be used as the catalyst.

As the hydrogen generating material, one kind of the materials described above may be used solely or two or more kinds of the materials may be used in combination.

The hydrogen generating material can be heated in a state of being mixed with water or heated water can be supplied thereto in order to enhance its reactivity with water.

Further, when the hydrogen generating material is used together with a heat generating material (material other than the hydrogen generating material) that generates heat by reacting with water, the temperature of the reaction system can be increased, due to the heat generated by the heat generating material even when water with a low temperature (for example, about 5° C.) is supplied thereto. Thus, hydrogen can be generated quickly.

Examples of the heat generating materials that generate heat by reacting with water include materials that become hydroxide as a result of reacting with water, such as calcium oxide, magnesium oxide, calcium chloride, magnesium chloride, and calcium sulfate, and oxides, chlorides, and sulfated compounds of an alkali metal or an alkaline-earth metal that generate heat by being hydrated. As described above, although metal hydrides, such as sodium borohydride, potassium borohydride, and lithium hydride, that generate hydrogen by reacting with water can be used as the hydrogen generating material, they also can be used as the heat generating material.

Particularly, when a metal such as aluminum, silicon, zinc, or magnesium, or an alloy that mainly contains one or more elements of aluminum, silicon, zinc, and magnesium is used as the hydrogen generating material, it is preferable to use the heat generating material in combination. In contrast, when one of the metal hydrides is used as the hydrogen generating material, hydrogen can be produced at a relatively favorable speed without using the heat generating material in combination. However, the speed of generating hydrogen may be increased by using the heat generating material in combination.

Although there is no particular limitation for the material for and the shape of the hydrogen-generating-material containing vessel 34 as long as the vessel can contain the hydrogen generating material 34a for generating hydrogen, it is preferable that the vessel is made of a material and have a shape from which water and hydrogen do not leak except from the water supply port or the hydrogen outflow port. Specifically, it is preferable that the material for the vessel is resistant to permesion of water and hydrogen and does not cause breakage of the vessel when heated to about 120° C. Metals such as aluminum andiron, and resins such as polyethylene and polypropylene can be used. A prismatic shape, a columnar shape and the like can be adopted as the shape of the vessel.

There is no particular limitation for the water containing vessel 35, and a water containing tank similar to that used in a conventional hydrogen generating apparatus can be adopted.

Hydrogen is generated by the water 35a in the water containing vessel 35 being supplied to the hydrogen-generating-material containing vessel 34 through the water supply pipe 38, and the water 35a reacting with the hydrogen generating material 34a in the hydrogen-generating-material containing vessel 34. However, there is a possibility that unreacted water in the hydrogen-generating-material containing vessel 34 is mixed into the generated hydrogen, and the mixture flows into the fuel cell through the hydrogen outflow pipe 40.

Therefore, in the hydrogen producing apparatus 2, it is preferable that a condensed water separator 37 is provided in the fuel channel for supplying hydrogen to the fuel cell. As shown in FIG. 4, hydrogen gas let out from the hydrogen-generating-material containing vessel 34 is introduced into the condensed water separator 37 through the hydrogen outflow pipe 39. During that time, moisture contained in the hydrogen gas is cooled within the hydrogen outflow pipe 39 and becomes condensed water. Since the condensed water drops onto a lower portion of the condensed water separator 37 due to gravity, the hydrogen gas and the water can be separated from each other. The separated hydrogen gas is supplied to the fuel cell through the hydrogen outflow pipe 40.

Further, as shown in FIG. 4, by coupling the condensed water separator 37 and the water containing vessel 35 with a water recovery pipe 41, the water separated at the condensed water separator 37 can be recovered into the water containing vessel 35. By recovering the separated water, water that is supplied to generate hydrogen can be used efficiently, and the water containing vessel 35 can be made more compact.

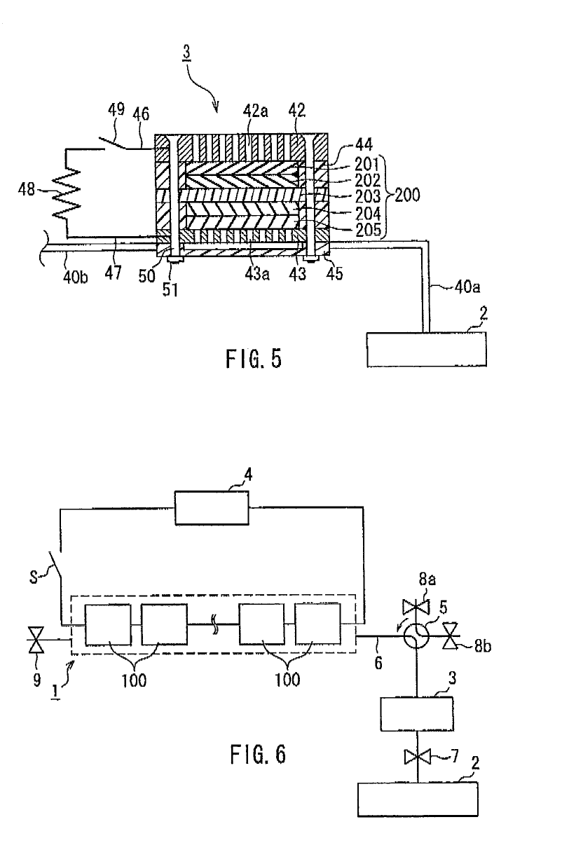

FIG. 5 is a schematic cross-sectional view showing one example of the hydrogen eliminating apparatus used in the fuel cell power generation system of the present invention. Although FIG. 5 shows only a cross-section of the hydrogen eliminating apparatus 3, hatching for indicating a cross-section is omitted for some components in order to facilitate the understanding of each component of the hydrogen eliminating apparatus 3.

The hydrogen eliminating apparatus 3 shown in FIG. 5 includes a second MEA 200 configured so that its positive electrode and negative electrode can be brought into electric conduction. The MEA 200 includes a positive electrode catalytic layer 202 for reducing oxygen and a negative electrode catalytic layer 204 for oxidizing hydrogen. The MEA 200 further includes a solid electrolyte membrane 203 disposed between the positive electrode catalytic layer 202 and the negative electrode catalytic layer 204. A positive electrode diffusion layer 201 is stacked on a surface of the positive electrode catalytic layer 202 opposite to the surface that is in contact with the solid electrolyte membrane 203. A negative electrode diffusion layer 205 is stacked on a surface of the negative electrode catalytic layer 204 opposite to the surface that is in contact with the solid electrolyte membrane 203. These components can be made of the same materials used to form the components of the MEAs 100 that are used in the fuel cell 1, which has been described with reference to FIG. 3.

The MEA 200 is interposed between a positive electrode collector plate 42 disposed on top of the positive electrode diffusion layer 201 and a negative electrode collector plate 43 disposed under the negative electrode diffusion layer 205, and the positive electrode collector plate 42 and the negative electrode collector plate 43 are fixed with bolts 50 and nuts 51, for example. Reference numeral 44 denotes sealing materials made of silicon rubber or the like, and reference numeral 45 denotes a tank (hydrogen tank).

The hydrogen eliminating apparatus 3 is coupled to the hydrogen producing apparatus 2 through a hydrogen outflow pipe 40a as a fuel channel. Hydrogen supplied from the hydrogen producing apparatus 2 passes through the inside of the hydrogen eliminating apparatus 3, and is supplied to the fuel cell through a hydrogen supply pipe 40b as a fuel channel.

The positive electrode collector plate 42 and the negative electrode collector plate 43 are made of a precious metal such as platinum or gold, an anti-corrosion metal such as stainless steel, carbon, or the like. In order to enhance the corrosion resistance, the surfaces of those materials may be plated or coated.

A plurality of air holes 42a are formed on the positive electrode collector plate 42, and oxygen in the air is supplied to the positive electrode of the MEA 200 through these air holes 42a. In contrast, surplus hydrogen that flows into the tank 45 is supplied to the negative electrode of the MEA 200 through a plurality of hydrogen inflow holes 43a formed on the negative electrode collector plate 43.

A positive electrode lead wire 46 is connected to an end portion of the positive electrode collector plate 42 and a negative electrode lead wire 47 is connected to an end portion of the negative electrode collector plate 43. These lead wires 46 and 47 are connected to each other through a resistance 48 and a switch 49. When the operation of the fuel cell 1 is stopped, in other words, when the external load is turned off, by turning on the switch 49 to bring the positive electrode and the negative electrode of the MEA 200 into conduction, surplus hydrogen that flows into the hydrogen eliminating apparatus 3 can be consumed. As a result, the surplus hydrogen that heads toward the fuel cell from the hydrogen eliminating apparatus 3 through the hydrogen supply pipe 40b can be eliminated completely or the amount thereof can be reduced significantly.

In the hydrogen eliminating apparatus 3 shown in FIG. 5, the positive electrode and the negative electrode of the MEA 200 are connected to each other through the resistance 48. The resistance value of the resistance 48 may be set such that the time required for a voltage between the positive electrode and, the negative electrode of the TEA 200 to drop to 0.1 V after the operation of the fuel cell is stopped is within one minute, for example. Further, the positive electrode and the negative electrode of the MEA 200 may be brought into conduction directly with a lead, instead of using the resistance 48. Further, the obtained current may be used to charge a secondary cell or may be used to operate the device.

The hydrogen supply pipe 40b that couples the hydrogen eliminating apparatus 3 and the fuel cell may be provided with an outlet, such as a cock, so that surplus hydrogen that heads toward the fuel cell from the hydrogen producing apparatus 2 can be let out from the fuel cell power generation system. In this case, surplus hydrogen that flows into the fuel cell from the hydrogen producing apparatus 2 when the fuel cell is not in operation is let out from the fuel cell generating system by the outlet, so that the deterioration of the fuel cell due to the hydrogen can be prevented with more certainty. When the hydrogen is let out from the system without being processed, it may lead to danger of inflaming or the like. By reducing the amount of surplus hydrogen that is let out with the hydrogen eliminating apparatus 3, it is also possible to avoid the danger.

### Embodiment 2

In the fuel cell power generation system according to Embodiment 1 with the fuel cell 1 being made to have high airtightness, when the hydrogen eliminating apparatus 3 is operated, the internal pressure of the fuel cell 1 may drop too much due to the residual hydrogen in the fuel cell 1 being consumed. In order to prevent the internal pressure from dropping more than necessary, the fuel cell power generation system of the present invention may be configured to take outside air into the fuel cell 1 at the stage where the residual hydrogen is consumed to a certain degree. For example, the fuel channel 6 or the like may be provided with an outside air inflow portion such as a cock. Further, the system may be configured so that a flow of hydrogen into the fuel cell 1 and the intake of outside air to the fuel cell 1 can be switched using a channel switching portion, which will be described below.

FIG. 6 is a schematic diagram showing one example of the fuel cell power generation system of the present invention provided with the channel switching portion. The fuel cell power generation system shown in FIG. 6 has the same configuration as the fuel cell power generation system shown in FIG. 1 except that a channel switching portion 5 is provided in the fuel channel 6, and the fuel cell 1 is provided with a backflow prevention valve 9.

FIG. 6 shows the fuel cell power generation system in a state where a flow of hydrogen to the fuel cell 1 from the hydrogen producing apparatus 2 and from the hydrogen eliminating apparatus 3 is allowed. By rotating the channel switching portion 5 by 90° in the arrow direction to disallow the flow of hydrogen in the fuel channel 6, it is possible to block hydrogen from flowing into the fuel cell 1 from the hydrogen eliminating apparatus 3 and to allow intake of outside air to the fuel cell 1. Reference numerals 8a and 8b denote on-off valves that are used to adjust the amount of outside air to be taken into the fuel cell 1 when the channel switching portion 5 is rotated by 90° in the arrow direction from the state shown in FIG. 6. The backflow prevention valve 9 enables a gas to flow only in one direction from the inside of the fuel cell 1 to the outside of the system. When an excessive amount of hydrogen is supplied to the fuel cell 1 from the hydrogen producing apparatus 2, the hydrogen can be let out from the system by operating the backflow prevention valve 9. In addition, it is also possible to prevent outside air from getting into the fuel cell 1 when the fuel cell 1 is in operation. Even in a case where the excessive amount of hydrogen cannot be processed only by the hydrogen eliminating apparatus 3, the hydrogen can be let out by operating the backflow prevention valve 9. Or, the system may be configured so that outside air can be taken into the fuel cell 1 when the pressure in the fuel cell 1 dropped by rotating the backflow prevention valve 9 into the opposite direction.

Further reference numeral 7 denotes a stop valve. By dosing the stop valve 7 in accordance with the operation of the fuel cell 1 being stopped, a supply of hydrogen to the fuel cell 1 from the hydrogen producing apparatus 2 can be shut off. Further, by opening the stop valve 7 in accordance with the operation of the fuel cell 1 being started, hydrogen can be supplied to the fuel cell 1 from the hydrogen production apparatus 2.

The hydrogen eliminating apparatus 3 can be operated in the same manner as the hydrogen eliminating apparatus of the fuel cell power generation system according to Embodiment 1.

When switching channels using the channel switching portion 5 after the operation of the fuel cell 1 is stopped, it is preferable to carry out the switching after a certain degree of time has elapsed from the beginning of operation of the hydrogen eliminating apparatus 3. When the channel switching portion 5 is in the state of being rotated by 90° in the arrow direction from the state shown in FIG. 6, the channel that heads toward the channel switching portion 5 from the hydrogen eliminating apparatus 3 is opened to the outside of the system by the channel switching portion 5. Thus, hydrogen that flows out from the hydrogen eliminating apparatus 3 may be let out from the system, and the amount of hydrogen that is let out from the system can be reduced by carrying out the switching in a state where hydrogen has been eliminated by the hydrogen eliminating apparatus 3 to a certain degree, in other words, after residual hydrogen in the fuel channel 6 has been consumed to a certain degree.

There is no particular limitation for the channel switching portion 5 as long as the portion has airtightness and is capable of switching two channels. In terms of the weight, the cost, and the arrangement of the fuel cell power generation system, a three-way valve or a four-way valve can be preferably used. Further by using a three-way or four-way solenoid valve that can be driven electrically, the channel switching portion 5 also can be controlled electrically.

There is no particular limitation for the material of which the channel switching portion 5 is made as long as the material has airtightness and corrosion resistance. Heat-resistant fluororesin such as polytetrafluoroethylene (PTFE), ethylene-tetrafluoroethylene copolymer (E/TFE), tetrafluoroethylene-hexafluoropropylene copolymer (FEP), and tetrafluoroethylene-perfluoroalkylvinylether copolymer (PFA), polypropylene, and a polyacetal resin can be preferably used.

Although the on-off valves 8a and 8b and the backflow prevention valve 9 are not essential components, it is preferable that they are provided in the system. The on-off valve 8a may be a backflow prevention valve that allows a gas to flow only in the direction toward the fuel cell 1, and the on-off valve 8b may be a backflow prevention valve that allows a gas to flow only in the direction toward the outside of the system. Furthermore, although FIG. 6 shows a configuration in which the external load 4 is connected to the fuel cell 1 through the switch (S), the external load 4 may be connected directly to the fuel cell 1.

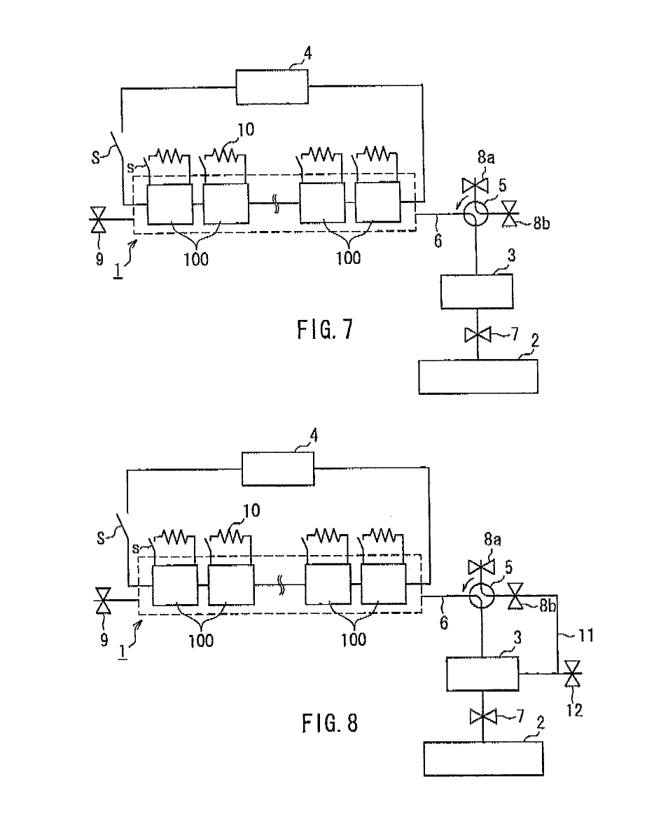

FIG. 7 is a schematic diagram showing another example of the fuel cell power generation system of the present invention provided with the channel switching portion. The fuel cell power generation system shown in FIG. 7 is different from the fuel cell power generation system shown in FIG. 6 in that the resistance 10 is connected to each of the individual MEAs 100 provided in the fuel cell 1 with a lead or the like. The positive electrode and the negative electrode of each MEA 100 can be brought into electric conduction through the resistance 10. The operating conditions and the like of each component of the fuel cell power generation system shown in FIG. 7 can be set in the same manner as the fuel cell power generation system shown in FIG. 2 or FIG. 6.

In the fuel cell power generation systems having the configurations shown in FIGS. 6 and 7, switching of channels using the channel switching portion 5 can be carried out immediately after the external load 4 is turned off (i.e., after a power supply to the external load 4 is stopped). However, in order to reduce the amount of hydrogen that is let out from the system, it is preferable to carry out the switching after the residual hydrogen has been reduced by the hydrogen eliminating apparatus 3 or the MEAs 100. Specifically, it is desirable to operate the channel switching portion 5 after the voltage of at least one of the individual MEAs 100 has dropped to 1 V or less, and more preferably to 0.5 V or less. Further, when a timing of carrying out the switching with the channel switching portion 5 is determined on the basis of the voltage of the fuel cell 1 as a whole, it is desirable to operate the channel switching portion 5 after the open circuit voltage of the fuel cell 1 has dropped to ½ or less of the level at the time when hydrogen is in circulation.

On the other hand, in a case where the fuel cell 1 has high airtightness, the internal pressure of the fuel cell 1 may drop too much due to consumption of residual hydrogen in the fuel cell 1. Thus, it is preferable to operate the channel switching portion 5 at the stage where the consumption of the residual hydrogen has not advanced too much. Specifically, it is preferable to operate the channel switching portion 5 in a state where all of the MEAs 100 in the fuel cell 1 have a voltage of 0.2 V or more. Further, in a case where a timing of carrying out the switching with the channel switching portion 5 is determined on the basis of the voltage of the fuel cell 1 as a whole, it is preferable to operate the channel switching portion 5 before the open circuit voltage of the fuel cell 1 drops to 1/10 of the level at the time when hydrogen is in circulation.

Normally, the concentration of the residual hydrogen in the fuel cell 1 is not uniform, and the MEAs 100 located on the upstream side of a hydrogen flow are likely to deteriorate due to the residual hydrogen. Thus, it is further preferable to operate the channel switching portion 5 in accordance with the voltage of the MEA 100 that is located closest to the hydrogen producing apparatus 2.

FIG. 8 is a schematic diagram showing another example of the fuel cell power generation system of the present invention. The fuel cell power generation system shown in FIG. 8 has the same configuration as the fuel cell power generation system shown in FIG. 7 except that a circulation path 11 is formed by connecting the on-off valve 8b and the hydrogen eliminating apparatus 3, and a backflow prevention valve 12 is provided so that hydrogen in the circulation path 11 is let out from the system only when the pressure in the circulation path 11 becomes abnormal.

In the fuel cell power generation systems shown in FIGS. 6 and 7 respectively, hydrogen that passed through the on-off valve 8b is let out from the system. In the fuel cell power generation system shown in FIG. 8, however, hydrogen that passed through the on-off valve 8b ran be sent back again to the hydrogen eliminating apparatus 3 through the circulation path 11. Therefore, the amount of hydrogen that is let out from the system ran be reduced and the efficiency in eliminating hydrogen can be enhanced.

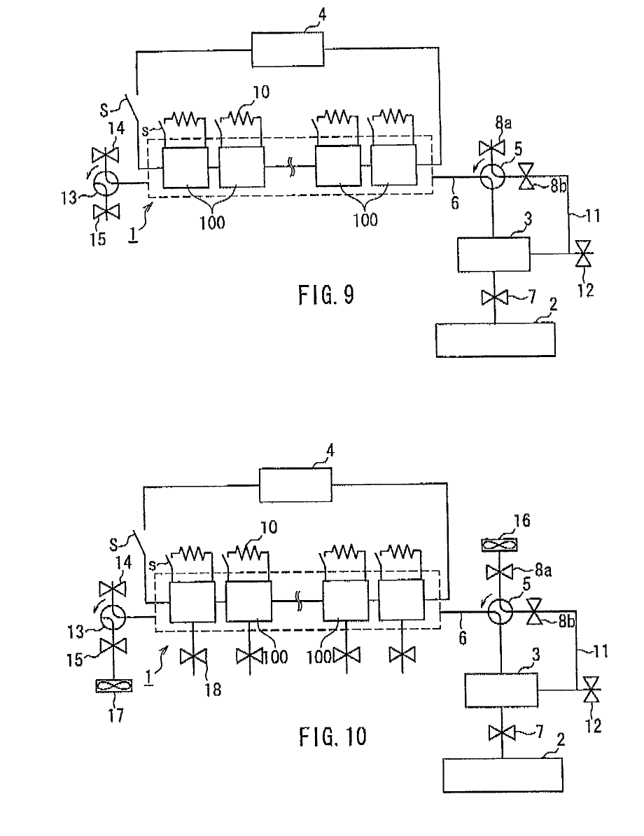

FIG. 9 is a schematic diagram showing another example of the fuel cell power generation system of the present invention. In the fuel cell power generation system shown in FIG. 9, a channel switching portion 13 is provided in place of the backflow prevention valve 9 used in the fuel cell power generation system shown in FIG. 8. A backflow prevention valve 14 and an valve 15 are connected to the channel switching portion 13.

In the fuel cell power generation system shown in FIG. 9, the fuel switching portion 13 is set to form channels on the fuel cell 1 side and on the backflow prevention valve 14 side when the fuel cell 1 is in operation, and to prevent outside air from flowing into the fuel cell 1 with the backflow prevention valve 14. After the operation of the fuel cell 1 is stopped, outside air can be taken into the fuel cell 1 by rotating the channel switching portion 13 by 90° in the arrow direction and opening the on-off valve 15. Thus, in the fuel cell power generation system shown in FIG. 9, the gas in the fuel cell 1 can be replaced more speedily than the fuel cell power generation systems having the configurations shown in FIGS. 7 and 8.

The number of the channel switching portion provided in the system may be only one as shown in FIGS. 6 to 8, or a plurality of the channel switching portions may be provided as shown in FIG. 9. Further, the channel switching portion 5 in FIG. 9 may be omitted and the channel switching portion 13 may be only provided. However, in terms of blocking with more certainty the entry of hydrogen into the fuel cell 1 after the operation of the fuel cell 1 is stopped, it is preferable that the channel switching portion is provided at least between the hydrogen eliminating apparatus 3 and the fuel cell 1. The conditions under which the channel switching portion 5 is operated in the fuel cell power generation systems having the configurations shown in FIGS. 8 and 9, and in FIG. 10, which will be described below, can be the same as the conditions that have been described with regard to the fuel cell power generation systems having the configurations shown in FIGS. 6 and 7.

FIG. 10 is a schematic diagram showing another example of the fuel cell power generation system of the present invention. The fuel cell power generation system shown in FIG. 10 has a configuration in which blowers 16 and 17 can let out the residual hydrogen in the system forcefully when taking outside air into the fuel cell 1 through the channel switching portions 5 and 13 after the operation of the fuel cell 1 is stopped. Further, a backflow prevention valve 18 is connected to each MEA 100.

In the fuel cell power generation system shown in FIG. 10, the blowers 16 and 17 are turned off when the fuel cell 1 is in operation. After the operation of the fuel cell 1 is stopped, by rotating the channel switching portions 5 and 13 by 90° in the arrow direction to switch the channels and operating the blowers 16 and 17, outside air is forcefully taken into the channels. At this time, if the directions in which the outside air is taken in by the blowers 16 and 17 are both the same as the direction in which the outside air is introduced into the fuel cell 1, as long as an outlet path provided with the backflow prevention valve 18 is provided in each MEA 100, a small amount of hydrogen that remains in the fuel cell 1 can be let out from the fuel cell 1 through the outlet path.

In contrast, the gas in the fuel cell 1 also can be replaced, for example, by operating the blower 16 so as to take outside air into the system and operating the blower 17 so as to let out the gas in the system. In this case, the displacement or the like can be adjusted with the on-off valves 8a and 15.

As described above, in the fuel cell power generation system having the configuration shown in FIG. 10, the gas in the fuel cell 1 can be replaced more speedily than the fuel cell generation systems having the configurations shown in FIGS. 6 to 9.

### Embodiment 3

Among the embodiments of the present invention that can deal with fluctuations of the pressure in the fuel cell, one example of an embodiment different from Embodiment 2 will be described below.

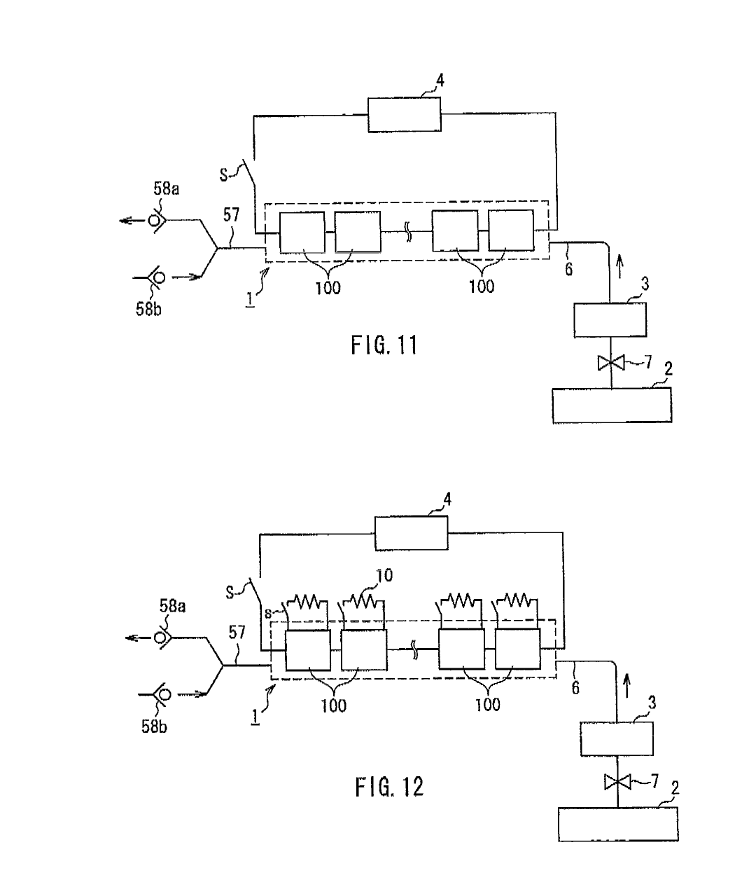

FIG. 11 is a schematic diagram showing one example of the fuel cell power generation system of the present invention provided with an internal pressure adjusting portions. The fuel cell power generation system shown in FIG. 11 has the same configuration as the fuel cell power generation system shown in FIG. 1 except that the fuel cell 1 is provided with the internal pressure adjusting portions.

In the fuel cell power generation system shown in FIG. 11, a ventilation path 57 connects the fuel channel 6 in the fuel cell 1 and the outside of fuel cell 1. Reference numerals 58a and 58b are backflow prevention portions as the inner pressure adjusting portions. The backflow prevention portion 58a can open only the channel in the direction in which the gas (hydrogen) in the fuel cell 1 is let out from the fuel cell 1 and the backflow prevention portion 58b can open only the channel in the direction in which outside air is taken into the fuel cell 1 from the outside of the fuel cell 1.

Reference numeral 7 denotes a stop valve. By dosing the stop valve 7 in accordance with the operation of the fuel cell 1 being stopped, a supply of hydrogen to the fuel cell 1 from the hydrogen producing apparatus 2 is shut off. Further, by opening the stop valve 7 in accordance with the operation of the fuel cell 1 being started, hydrogen can be supplied to the fuel cell 1 from the hydrogen producing apparatus 2.

The hydrogen eliminating apparatus 3 is operated when the external load 4 is turned off in other words, when a supply of power to the external load 4 from the fuel cell 1 is stopped. Thus, when a supply of hydrogen to the fuel cell 1 from the hydrogen producing apparatus 2 continues or when surplus hydrogen flows into the fuel cell 1 even after the supply of hydrogen is stopped using the stop valve 7, the hydrogen that heads toward the fuel cell 1 can be eliminated with the hydrogen eliminating apparatus 3. As a result, the supply of hydrogen into the fuel cell 1 stops, or the amount thereof is significantly reduced.

Further, when the hydrogen eliminating apparatus 3 is capable of eliminating an amount of hydrogen larger than the surplus hydrogen supplied from the hydrogen producing apparatus 2, not only hydrogen from the hydrogen producing apparatus 2 but also the surplus hydrogen that remains in the fuel cell 1 can be eliminated.

The hydrogen eliminating apparatus 3 also can be operated when the fuel cell 1 is in operation. For example, when the amount of hydrogen supply exceeds the amount of hydrogen required to generate power at the fuel cell 1, the surplus hydrogen can be eliminated by operating the hydrogen eliminating apparatus 3 so as to adjust the amount of hydrogen supply to the fuel cell 1.

Further, when the pressure in the fuel cell 1 becomes too high due to fluctuations in the amount of hydrogen supplied to the fuel cell 1 from the hydrogen producing apparatus 2, the gas in the fuel cell 1 can be let out from the fuel cell 1 by operating the backflow prevention portion 58a.

In contrast, when the pressure in the fuel cell 1 becomes too low due to the consumption of hydrogen by the hydrogen eliminating apparatus 3, outside air can be taken into the fuel cell 1 speedily with the backflow prevention portion 58b. Due to these effects, it is possible to prevent breakage of the fuel cell 1 due to the fluctuations of the pressure in the fuel cell 1, and to maintain outputs of the fuel cell 1 stably.

Although the fuel cell power generation system of the present invention may include either one of the backflow prevention portions 58a and 58b, it is preferable that the system includes the both backflow prevention portions.

There is no particular limitation for the backflow prevention portions that can be used in the fuel cell power generation system of the present invention as bang as the portions have airtightness and a function of allowing air to flow in one direction. Directional check valves such as a lift-check valve having a valve disc that moves in parallel, a swing check valve having a valve disc that swings on a hinge, and a ball check valve having a spherical valve disc; and pressure control valves such as a pressure reducing valve, a safety valve, and a relief valve (check valve) that have a structure of naturally letting out the gas with the valve when the pressure fluctuates by a certain degree or more can be preferably used. By using a solenoid valve of one of the above-mentioned types that can be driven electrically, it is possible to electrically control the ability to let out the gas from the fuel cell, or to take outside air into the fuel cell.

Although a preferred pressure in the backflow prevention portions at the time of starting an opening operation may vary in accordance with the size and the like of the fuel cell power generation system, it is preferable that the pressure is 1.0 MPa or less in gauge pressure, for example. Further, in a case where the fuel power generation system includes both the backflow prevention portion 58a for opening the channel only in the direction in which gas is let out from the fuel channel in the fuel cell 1 to the outside of the fuel cell 1, and the backflow prevention portion 58b for opening the channel only in the direction in which outside air flows into the fuel channel in the fuel cell 1 from the outside of the fuel cell 1, although a preferred difference in pressure between the backflow prevention portions 58a and 58b at the time of starting the opening operation also may vary in accordance with the size of the fuel cell power generation system, it is preferable that the difference is in a range of 0 to 0.5 MPa. When the backflow prevention portions 58a and 58b are set to have different pressures at the time of starting the opening operation, the pressure in the backflow prevention portion 58b at the time of starting the opening operation is preferably set higher than that in the backflow prevention portion 58a in order to prevent output drop due to outside air being taken into the fuel cell 1 when the fuel cell 1 is in operation.

There is no particular limitation for the material of which the backflow prevention portions are made as long as the material has airtightness and corrosion resistance. For example, thermo fluoroplastics such as polytetrafluoroethylene (PTFE), ethylene-tetrafluoroethylene copolymer (E/TFE), tetrafluoroethylene-hexafluoropropylene copolymer (FEP), and tetrafluoroethylene-perfluoroalkylvinylether copolymer (PFA), polypropylene (PP), and a polyacetal resin can be preferably used.

FIG. 12 is a schematic diagram showing another example of the fuel cell power generation system of the present invention. The fuel cell power generation system shown in FIG. 12 is different from the fuel cell power generation system shown in FIG. 11 in that the resistance 10 is connected to each of the individual MEAs 100 provided in the fuel cell 1 with a lead or the like. The positive electrode and the negative electrode of each MEA 100 can be brought into electric conduction through the resistance 10. The operating conditions and the like of each component of the fuel cell power generation system shown in FIG. 12 can be set in the same manner as the fuel cell power generation system shown in FIG. 2 or FIG. 11.

In the fuel cell power generation system shown in FIG. 12, when residual hydrogen in the fuel cell 1 is consumed by turning off the external load 4 and turning on the switch (s) provided on the lead that connects the positive electrode and the negative electrode of each of the individual MEAs 100, the pressure in the fuel cell 1 drops. In this case, the backflow prevention portion 58b is automatically opened to take outside air into the fuel cell 1 so as to prevent the internal pressure from dropping. As a result, breakage of the fuel cell 1 can be prevented.

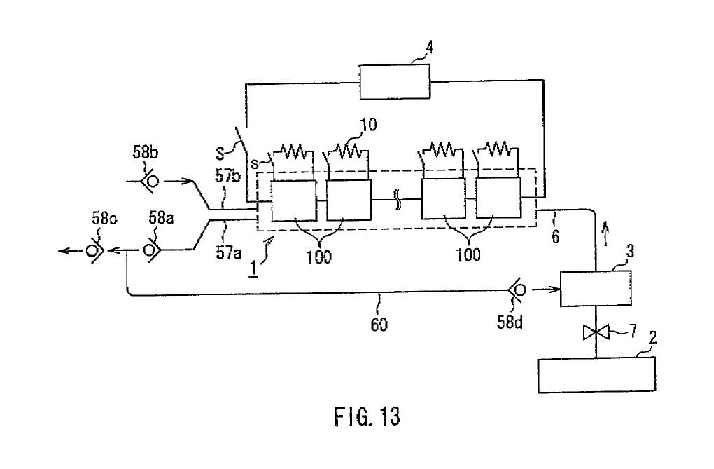

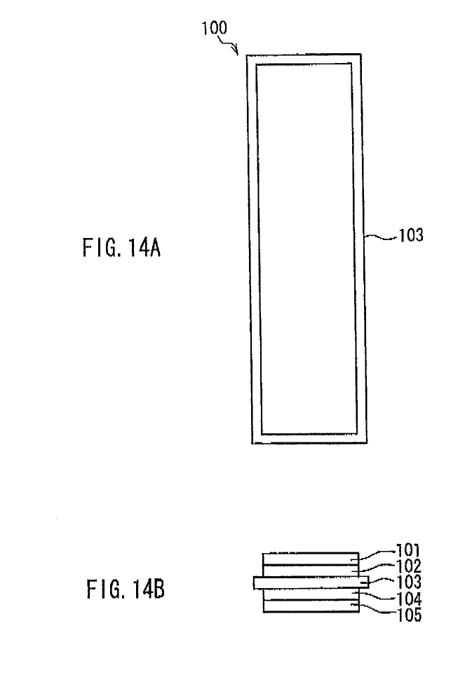

In a case the ventilation path 57 is branched in a T-shape as in the fuel cell power generation systems shown in FIGS. 11 and 12, there is a possibility that water or the like generated in the fuel cell 1 enters the ventilation path 57 and causes deterioration of the function of the backflow prevention portion 58b when letting out hydrogen or the like from the fuel channel 6 in the fuel cell 1 to the outside of the fuel cell 1 using the backflow prevention portion 58a. In such a case, ventilation paths connected respectively to the backflow prevention portions 58a and 58b may be provided separately as in the configuration shown in FIG. 13, which will be described below.

A plurality of either one of or both of the backflow prevention portions 58a and 58b may be provided in the fuel cell power generation system of the present invention.

FIG. 13 is a schematic diagram showing another example of the fuel cell power generation system of the present invention. The fuel cell power generation system shown in FIG. 13 includes separate ventilation paths 57a and 57b, and the ventilation path 57a is branched in a T-shape on a side of the backflow prevention portion 58a from which the gas is let out. One end of the branched ventilation path 57a is provided with a backflow prevention portion 58c for opening the channel only in the direction in which the gas is let out to the outside from the ventilation path 57a side, and the other end is connected to the hydrogen eliminating apparatus 3 and forms a ventilation path 60. The ventilation path 60 is provided with a backflow prevention portion 58d for opening the channel only in the direction in which the gas flows into the hydrogen eliminating apparatus 3. In the fuel cell power generation system shown in FIG. 13, surplus gas that was let out through the ventilation path 57a in the fuel cell 1 and through the backflow prevention portion 58a can be introduced into the hydrogen eliminating apparatus 3 through the ventilation path 60 and through the backflow prevention portion 58d. Thus, the amount of hydrogen that is let out from the fuel cell 1 through the ventilation path 57a can be reduced, and thereby the efficiency in eliminating hydrogen can be improved.

In the fuel cell power generation system shown in FIG. 13, although a preferable range of differences in pressure among the backflow prevention portions 58a, 58c, and 58d at the time of starting the opening operation may vary in accordance with the size of the system, it is preferable that a difference in pressure between the backflow prevention portions 58a and 58c, a difference in pressure between the backflow prevention portions 58a and 58d, and a difference in pressure between the backflow prevention portions 58c and 58d are all in a range of 0 to 0.5 MPa. Further, when the backflow prevention portions 58a, 58c, and 58d are set to have different pressures at the time of starting the opening operation, it is preferable that the relationship in terms of the pressure size among the back low prevention portions 58a, 58c, and 58d at the time of starting the opening operation satisfies 58c>58a>58d.

Although the present invention has been described with reference to FIGS. 1 to 13, FIGS. 1 to 13 merely show the present invention by way of example. Thus, the fuel cell power generation system of the present invention is not limited to the configurations shown in FIGS. 1 to 13.

Hereinafter, the present invention will be described in detail on the basis of examples.

### Example 1

### Production of Fuel Cell

First, a fuel cell having the structure shown in FIG. 3 was produced. MEAs having the configuration shown in FIGS. 14A and 1413 were used as the first MEAs 100. FIG. 14A is a plan view showing the MEA 100 and FIG. 14B is a cross-sectional view showing the MEA 100. In FIG. 14B, hatching for indicating a cross-section is omitted in order to facilitate the understanding of each component. For the positive electrode and the negative electrode of each MEA 100, electrodes obtained by applying Pt supporting carbon to a carbon cloth (“LT 140E-W” manufactured by E-TEK; Pt amount: 0.5 mg/cm²) were used. Further, for the solid electrolyte membrane 103, “Nation 112” manufactured by DuPont was used. The size of each electrode was 25 mm×92 mm and the size of the solid electrolyte membrane was 29 mm×96 mm.

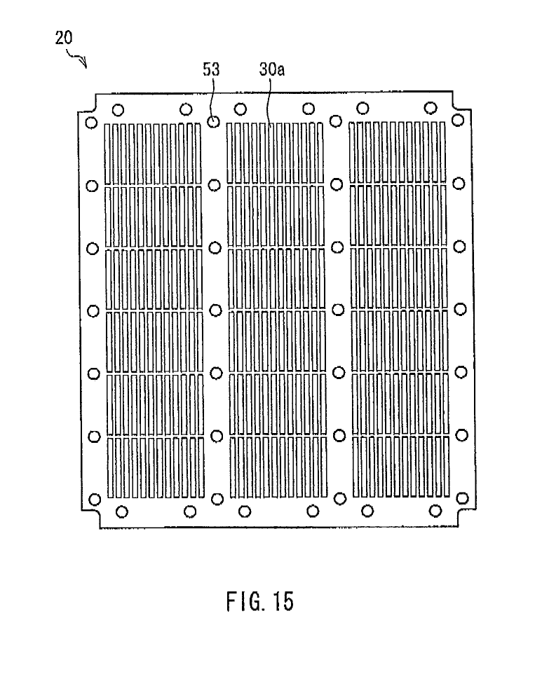

FIG. 15 is a plan view showing the positive electrode panel plate 20 used in the production of the fuel cell 1. The positive electrode panel plate 20 used in the production of the fuel cell 1 was made of stainless steel (SUS304) and had a thickness of 2 mm. In FIG. 15, reference numeral 30a denotes oxygen inflow holes that constitute the positive electrode openings 30 in FIG. 3. Reference numeral 53 denotes screw holes through which the positive electrode panel plate 20 and the negative electrode panel plate 21 are fixed with the bolts 32 and the nuts 33. To correspond with the positive electrode diffusion layer 101 of each of the MEAs 100, on the positive electrode panel plate 20, three sets of rectangular holes having a size of 1×13 mm were formed as the oxygen inflow holes 30a, where one set consisted of a total of 72 rectangular holes, 12 across and 6 down. The negative electrode panel plate 21 was made of the same material and had the same shape as the positive electrode panel plate 20. That is, the openings formed on the panel plates function as the oxygen inflow holes that constitute the positive electrode openings 30 in the positive electrode, and they function as the fuel inflow holes that constitute the negative electrode openings 31 in the negative electrode.

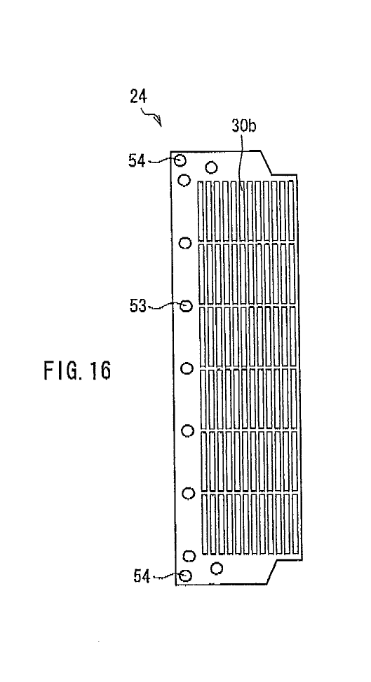

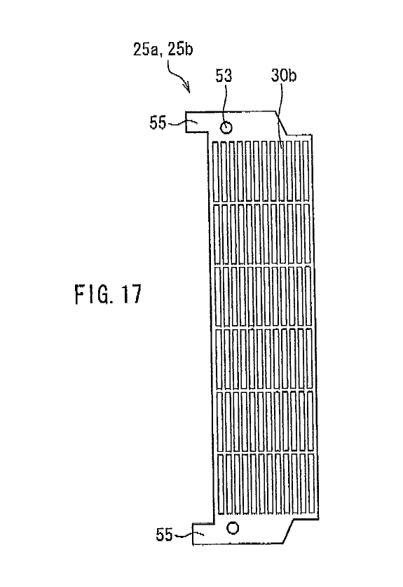

Further, FIG. 16 is a plan view showing the positive electrode collector plate (positive electrode end collector plate) 24 and FIG. 17 is a plan view showing the positive electrode collector plates 25a and 25b used in the production of the fuel cell 1. In FIGS. 16 and 17, reference numeral 30b denotes oxygen inflow holes that constitute the positive electrode openings 30 shown in FIG. 3. Further, the positive electrode end collector plate 24 shown in FIG. 16 is provided with positive electrode collector terminal portions 54 and the positive electrode collector plates 25a and 25b shown in FIG. 17 are respectively provided with two positive electrode series connection tabs 55.

The positive electrode collector plates 24, 25a, and 25b that were used in the production of the fuel cell 1 were made of nickel and plated with gold, and had a thickness of 0.3 mm. The oxygen inflow holes 30b and the screw holes 53 had the same shape and the same arrangement as the oxygen inflow holes and the screw holes on the positive electrode panel plate 20. Further, the negative electrode end collector plate 26 was made of the same material and had the same shape as the positive electrode end collector plate 24. The negative electrode plates 27a and 27b were made of the same material and had the same shape as the positive electrode collector plates 25a and 25b. That is, the openings on the panel plates function as the oxygen inflow holes that constitute the positive electrode openings 30 in the positive electrode, and they function as fuel inflow holes that constitute the negative electrode openings 31 in the negative electrode.

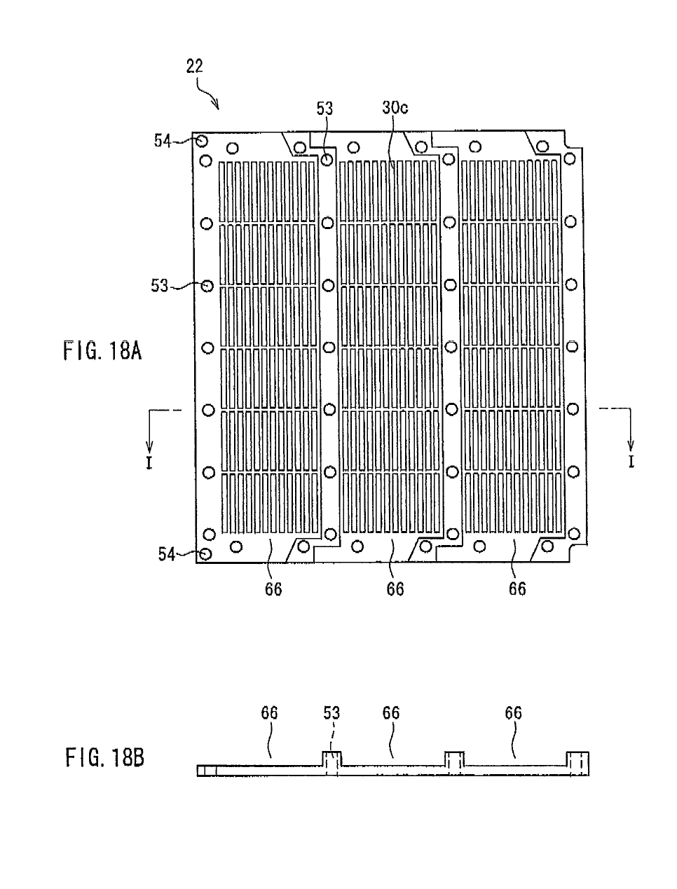

FIGS. 18A and 1813 show positive electrode insulating plates 22 used in the production of the fuel cell 1. FIG. 18A is a plan view showing the positive electrode insulating plate 22. FIG. 10 is a cross-sectional view along the line I-I in FIG. 18A. In FIG. 18B, since an arrangement of the screw holes 53 is indicated in a dotted line, hatching for indicating a cross-section is omitted in order to facilitate the understanding of the arrangement. The positive electrode insulating plate 22 is disposed between the positive electrode panel plate 20 and the positive electrode collector plates 24, 25a and 25b all of which are made of metal, midis for insulating these plates from each other. In FIGS. 18A and 1813, reference numeral 66 denotes concave portions for housing the positive electrode collector plates 24, 25a, and 25b.

The positive electrode insulating plate 22 used in the production of the fuel cell 1 was made of a glass epoxy resin and had a thickness of 0.5 mm. The oxygen inflow holes 30c and the screw holes 53 had the same shape and the same arrangement as the oxygen inflow holes and the screw holes on the positive electrode panel plate 20. Further, the negative electrode insulating plate 22 was made of the same material and had the same shape as the positive electrode insulating plate 23. That is, the openings on the insulating plates function as the oxygen inflow holes that constitute the positive electrode openings 30 in the positive electrode, and they function as the fuel inflow hales that constitute the negative electrode openings 31 in the negative electrode.

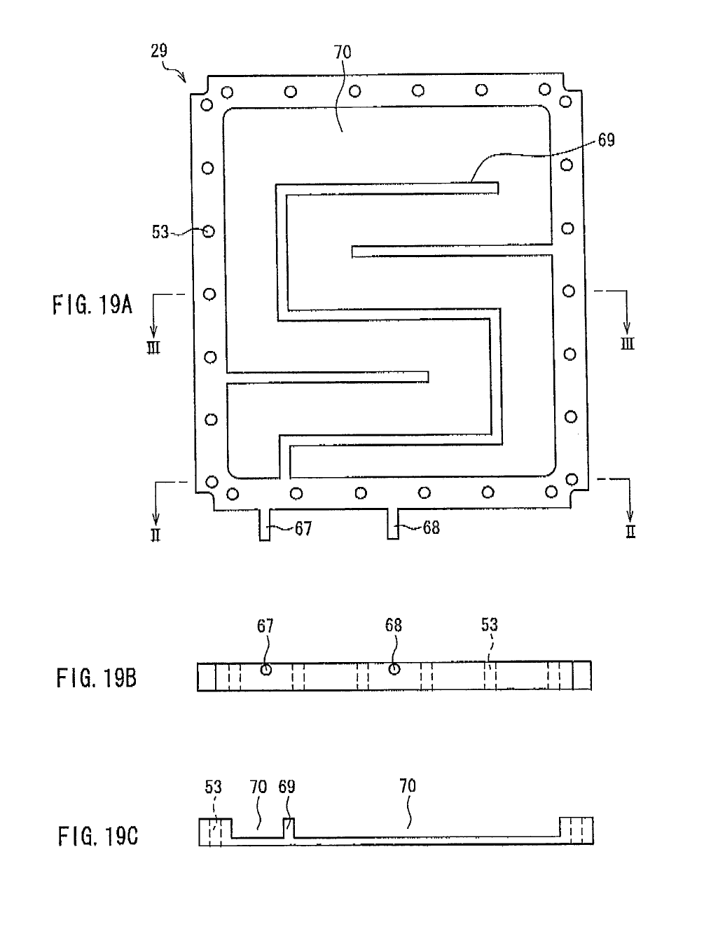

FIGS. 19A, 19B, and 19C show the fuel tank 29 used in the production of the fuel cell 1. FIG. 19A is a plan view showing the fuel tank 29. FIG. 19B is a cross-sectional view along the line II-II in FIG. 19A, and FIG. 19C is a cross-sectional view along the line III-III in FIG. 19A. In these cross-sectional views, since the arrangement of the screw holes 53 is indicated in a dotted line, hatching for indicating a cross-section is omitted in order to facilitate the understanding of the arrangement.

The fuel tank 29 is provided for supplying fuel to the negative electrode of each MEA 100 and for retaining the fuel. The fuel tank 29 includes a fuel supply port 67 for supplying the fuel, and a fuel outlet 68 for letting out the fuel. The fuel tank 29 further includes a fuel distribution guide 69 so that the fuel is supplied uniformly to each MEA 100. The fuel is retained in a tank inner portion 70.

The fuel tank 29 used in the production of the fuel cell 1 was made of a glass epoxy resin and had a thickness of 3 mm. The depth of the tank inner portion 70 at the center was 2 mm.

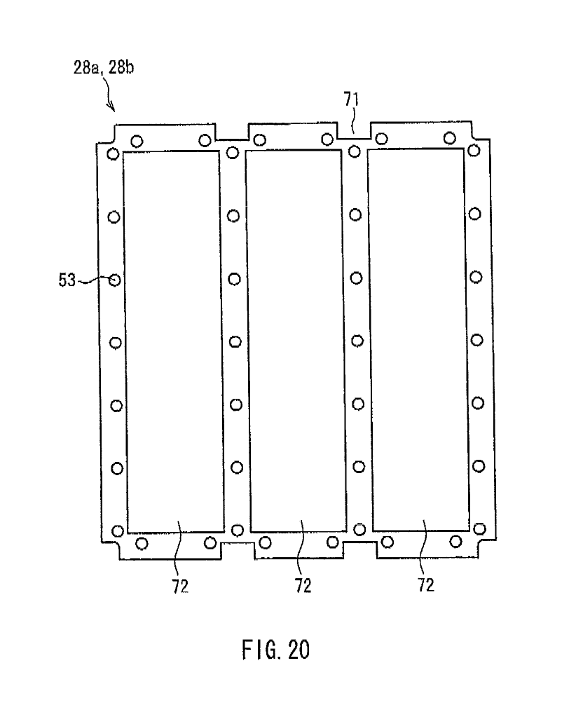

FIG. 20 is a plan view showing the sealing materials 28a and 28b used in the production of the fuel cell 1. The sealing materials 28a and 28b are disposed respectively on top and bottom of the MEAs 100. When they are disposed on the MEAs 100, the electrodes of the MEAs 100 are housed in holes 72 provided on the sealing materials 28a and 28b, and parts of the solid electrolyte membrane 103 that stick out from the electrode portions are interposed by the sealing materials 28a and 28b. By adopting such a configuration, the fuel and oxygen in the air are isolated from each other, and the fuel cell 1 can be operated favorably. The sealing materials 28a and 28b are provided with series connection tab contact areas 71. In these areas, the positive electrode series connection tabs provided on the positive electrode collector plate and the negative electrode series connection tabs provided on the negative electrode collector plate are brought into electric contact with each other so as to connect each MEA 100 in series.

The sealing materials 28a and 28b used in the production of the fuel cell 1 were made of silicon rubber, and had a thickness of 0.2 mm. The size of the holes 72 for housing the electrodes was 26 mm×93 mm.

The members described above were stacked on top of each other in the order shown in FIG. 3, were integrated using the bolts 32 and the nuts 33, and the three MEAs 100 were connected to each other in series, and thereby the fuel cell 1 was produced. Further, leads were respectively attached to the positive electrode and the negative electrode of each MEA 100, and a resistance of 10Ω and a switch were connected to the leads so that the positive electrode and the negative electrode could be brought into conduction.

<Production of Hydrogen Eliminating Apparatus>

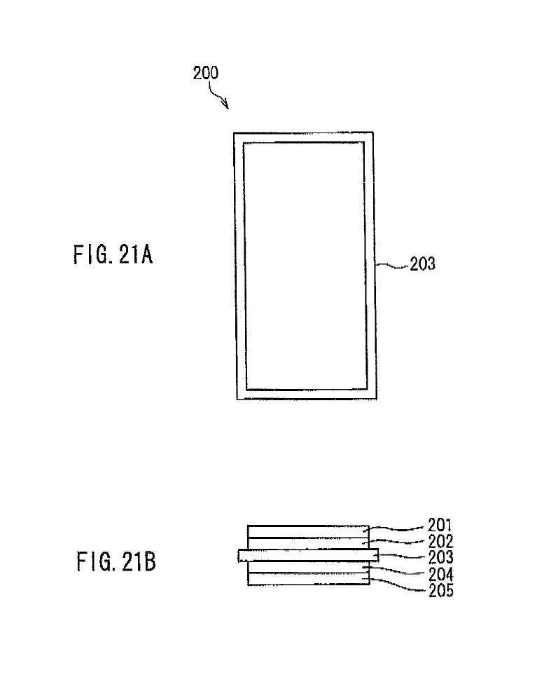

Next, the hydrogen eliminating apparatus 3 having the structure shown in FIG. 5 was produced. An MEA having the configuration shown in FIGS. 21A and 21B was used as the second MEA 200. FIG. 21A is a plan view showing the MEA 200 and FIG. 21B is a cross-sectional view showing the MEA 200. In FIG. 21B, hatching for indicating a cross-section is omitted in order to facilitate the understanding of each component. The positive electrode and the negative electrode and the solid electrolyte membrane in the MEA 200 were the same as those of each MEA 100 in the fuel cell 1. The size of the electrodes was 30 mm×60 mm, and the size of the solid electrolyte membrane was 34 mm×64 mm.

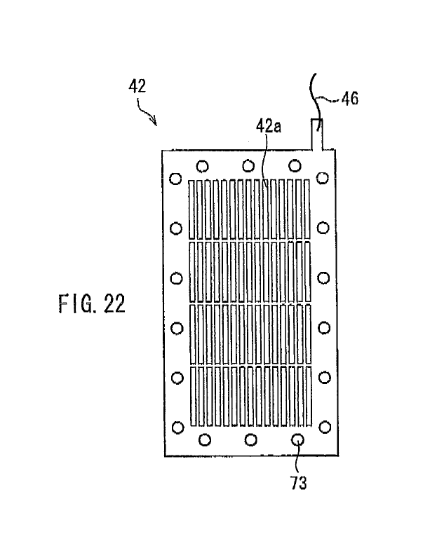

FIG. 22 is a plan view showing the positive electrode collector plate 42 used in the production of the hydrogen eliminating apparatus 3. In FIG. 22, reference numeral 73 denotes screw holes through which the positive electrode collector plate 42, the negative electrode collector plate 43, and a tank 45 of the hydrogen eliminating apparatus 3 are fixed with the bolts 50 and the nuts 51. Further, a positive electrode lead wire 46 is connected to an end portion of the positive electrode collector plate 42.

The positive electrode collector plate 42 used in the production of the hydrogen eliminating apparatus 3 was made of nickel and plated with gold, and had a thickness of 2 mm. On the positive electrode collector plate 42, a total of 60 rectangular holes, 15 across and 4 down, having a size of 1×13 mm were formed as air holes 42a so as to correspond with the positive electrode diffusion layer 201 in the MEA 200. The negative electrode collector plate 43 was made of the same material and had the same shape as the positive electrode collector plate 42. That is, the openings on the collector plates function as the air holes 42a in the positive electrode, and they function as the hydrogen inflow holes 43a shown in FIG. 5 in the negative electrode.

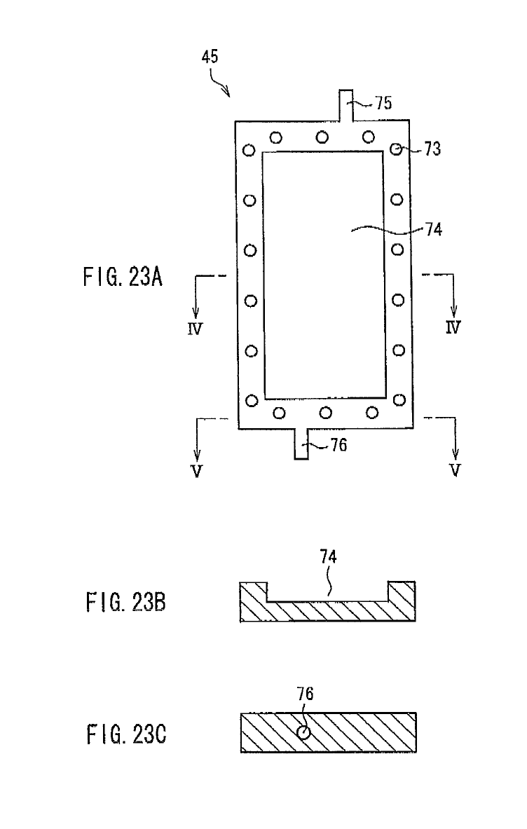

FIGS. 23A, 23B, and 23C show the tank 45 used in the production of the hydrogen eliminating apparatus 3. FIG. 23A is a plan view showing the tank 45, FIG. 23B is a cross-sectional view along the line IV-IV in FIG. 23A, and FIG. 23C is a cross-sectional view along the line V-V in FIG. 23A. The tank 45 is provided for retaining hydrogen that flows into the hydrogen eliminating apparatus 3 from the hydrogen producing apparatus 2, and for supplying the hydrogen to the negative electrode of the MEA 200. The tank 45 includes a hydrogen supply port 75 for supplying the hydrogen and a hydrogen outlet 76 for letting out the hydrogen. The hydrogen is retained in a tank inner portion 74. In FIG. 23A, reference numeral 73 denotes screw holes.

The tank 45 used in the production of the hydrogen eliminating apparatus 3 was made of a glass epoxy resin, and had a thickness of 3 mm. The depth of the tank inner portion 74 at the center was 2 mm.

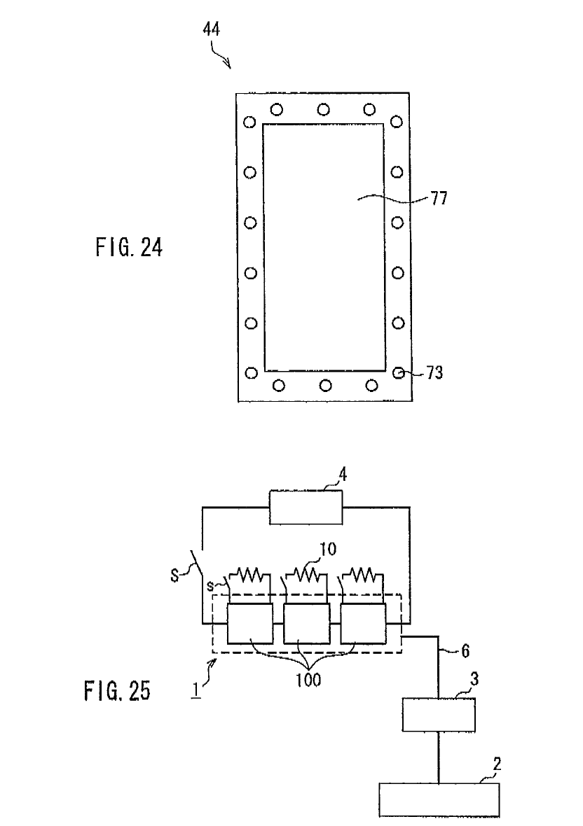

FIG. 24 is a plan view showing one of the sealing members 44 used in the production of the hydrogen eliminating apparatus 3. The sealing members 44 were made of silicon rubber and had a thickness of 0.2 mm, and a hale 77 with a size of 31 mm×61 mm was formed thereon to house the electrode of the MEA 200. In FIG. 24, reference numeral 73 denotes screw holes.

The members described above were stacked on top of each other in the order shown in FIG. 5, and were integrated using the baits 50 and the nuts 51. Furthermore, the positive electrode lead wire 46 and a negative electrode lead wire 47 were respectively attached to the positive electrode collector plate 42 and the negative electrode collector plate 43, a resistance 48 of 20 mΩ and a switch 49 were respectively connected to the lead wires so that the positive electrode and the negative electrode of the MEA 200 could be brought into conduction.

<Production of Hydrogen Producing Apparatus>

Next, the hydrogen producing apparatus 2 as a hydrogen source having the configuration shown in FIG. 4 was produced. A prismatic vessel made of polypropylene and having an internal volume of 50 cm³ was used as the hydrogen-generating-material containing vessel 34. Pipes made of polypropylene and having an inner diameter of 2 mm and an outer diameter of 3 mm were used as the water supply pipe 38, the hydrogen outflow pipes 39, and 40, and the water recovery pipe 41. A compound of 19.7 g of aluminum powder having a mean particle diameter of 3 μm as the hydrogen generating material and 2.5 g of calcium oxide as the heat generating material was placed in the hydrogen-generating-material containing vessel 34. A prismatic vessel made of polypropylene and having an internal volume of 50 cm³ was used as the water containing vessel 35, and 45 g of water was put therein. A prismatic vessel made of polypropylene and having an internal volume of 30 cm³ was used as the condensed water separator 37.

<Assembly of Fuel Cell Power Generation System>

By using the fuel cell 1, the hydrogen producing apparatus 2, and the hydrogen eliminating apparatus 3 as described above, a fuel cell power generation system having the configuration shown in FIG. 25 was assembled. The number of the MEAs 100 used in the fuel cell power generation system shown in FIG. 25 was three. This system had the same configuration as the fuel cell power generation system shown in FIG. 2, except that the stop valve 7 was not provided. A pipe made of polypropylene and having an inner diameter of 2 mm and an outer diameter of 3 mm was used as a hydrogen supply pipe (the hydrogen supply pipe 40b in FIG. 5) for coupling the fuel cell 1 and the hydrogen eliminating apparatus 3.

<Power Generation Test>

A power generation test was conducted at 25° C. by using the fuel cell power generation system described above. By using the water supply pump 36 tithe hydrogen producing apparatus 2, the water 35a in the water containing vessel 35 was supplied to the hydrogen-generating-material containing vessel 34 to generate hydrogen, and the hydrogen was supplied to the fuel cell 1. By turning on the external load 4, the fuel cell 1 was operated with at a constant voltage of 2.0 V, and power was generated for 4 hours. After the power generation, the external load 4 was turned off, and further, the water supply by the water supply pump 36 was stopped, and simultaneously the switch 49 of the hydrogen eliminating apparatus 3 was turned off. At the same lime, the switch (s) provided on each MEA 100 was turned on to bring the positive electrode and the negative electrode of each MEA 100 into electric conduction. On the next day, the hydrogen-generating-material containing vessel 34 and the water containing vessel 35 were removed from the system, the same amount of the hydrogen generating material and water were newly put again in the respective vessels, and power generation was started under the same conditions as described above. The test was conducted repeatedly every day.

### Comparative Example 1

A fuel cell power generation system was produced in the same manner as Example 1 except that the hydrogen eliminating apparatus 3 was not provided. A power generation test was conducted repeatedly under the same conditions as in Example 1.

On the bis of a power generation output at the first power generation test conducted on each of the fuel cell power generation systems of Example 1 and Comparative Example 1, the number of power generation tests that can be repeated until the power generation output drops to 80% of the level of the first power generation output was measured. TABLE 1 shows the results of the measurements.

TABLE 1

| | Repeated number of |
|---|---|
| | power generation tests |
| Example 1 | 94 |
| Comparative Example 1 | 14 |

As can be seen from TABLE 1, in the fuel cell power generation system of Example 1, the number of power generations in which outputs were able to retain 80% of the level of the first power generation output was 94. In contrast, in the fuel cell power generation system of Comparative Example 1, the number was 14. With the hydrogen source having a system of generating hydrogen by using a reaction between the hydrogen generating material and water as adopted in the fuel cell power generation systems of Example 1 and Comparative Example 1, hydrogen is kept being generated for a little while even after the contact between the hydrogen generating material and water is stopped. Since the fuel cell power generation system of Comparative Example 1 was not provided with a hydrogen eliminating apparatus, hydrogen was supplied to the fuel cell for a long time. Thus, in Comparative Example 1, it appears that the deterioration of the positive electrode and the negative electrode advanced due to the occurrence of the growth of the catalyst particles, the oxidization of the carbon powder, and the like. In contrast, in the fuel cell power generation system of Example 1, it appears that since the deterioration was prevented as a result of providing the hydrogen eliminating apparatus, the properties of the fuel cell were able to be maintained for a longer period of time than the fuel cell power generation system of Comparative example 1.

### Example 2

By providing the fuel channel that connects the hydrogen eliminating apparatus 3 and the fuel cell 1 with a channel switching portion, and providing the fuel cell 1 with a backflow prevention valve in the fuel cell power generation system of Example 1, a system similar to the fuel cell power generation system shown in FIG. 7 was configured. However, the number of the MEAs 100 used in the system of this example was three, and the stop valve 7 was not provided.

<Power Generation Test>

A power generation test was conducted at 25° C. by using the fuel cell power generation system of Example 2. By using the water supply pump 36 of the hydrogen producing apparatus 2, the water 35a in the water containing vessel 35 was supplied to the hydrogen-generating-material containing vessel 34 to generate hydrogen, and the hydrogen was supplied to the fuel cell 1. By turning on the external load 4, the fuel cell 1 was operated at a constant voltage of 2.0 V, and power was generated for 4 hours. After the power generation, the external load 4 was turned off, and further the water supply by the water supply pump 36 was stopped, and simultaneously, the switch 49 of the hydrogen eliminating apparatus 3 was turned on. At the same time, the switch (s) provided on each MEA 100 was turned on to bring the positive electrode and the negative electrode of each MEA 100 into electric conduction. Furthermore, the channel switching portion 5 was operated to switch channels when the voltage of each MEA 100 in the fuel cell 1 became 1 V or less.

### Example 3

A power generation test was conducted in the same manner as in Example 2 except that the switch (s) provided on each MEA 100 in the fuel cell 1 was not turned on.

### Example 4

A power generation test was conducted in the same manner as in Example 3 except that the channel switching portion 5 was not operated.

### Comparative Example 2

A power generation test was conducted in the same manner as in Example 1 except that the switch CO provided on each MEA 100 in the fuel cell power generation system of Comparative Example 1 was not turned on.

In power generation tests conducted in each of Examples 2 to 4 and Comparative Example 2, a change in the voltage of the fuel cell 1 was measured after the operation of the fuel cell 1 had been stopped, in other words, after the external load 4 had been turned off, and the time required for the voltage to drop to 1.5 V was determined. TABLE 2 shows the results.

TABLE 2

| | Time required for |
|---|---|
| | voltage drop |
| Example 2 | 20 seconds |
| Example 3 | 80 seconds |
| Example 4 | 80 seconds |
| Comparative | 1,000 seconds or more |
| Example 2 | |

Since a hydrogen supply to the fuel cell 1 side from the hydrogen producing apparatus 2 continued for a while after the water supply pump 36 had been stopped, as shown in TABLE 2, a considerable amount of time was required for the voltage to drop in the fuel cell power generation system of Comparative Example 2 which was not provided with the hydrogen eliminating apparatus 3. In contrast, in the fuel cell power generation systems of Examples 2 to 4 each of which was provided with the hydrogen eliminating apparatus 3, since an amount of hydrogen that flowed into the fuel cell 1 was reduced significantly by the hydrogen eliminating apparatus 3, the voltage of the fuel cell 1 was able to drop in a short time. Particularly, in the fuel cell power generation system of Example 2 in which each MEA 100 in the fuel cell 1 was also used to eliminate hydrogen, it was possible to process the surplus hydrogen in a shorter time.

In the fuel cell power generation systems of Examples 2 and 3, a flow of hydrogen into the fuel cell 1 was able to be prevented due to the operation of the channel switching portion 5. In contrast, in the fuel cell power generation system of Example 4, hydrogen that was not consumed by the hydrogen eliminating apparatus 3 continued to flow into the fuel cell 1 for a while. Therefore, it is desirable to use the hydrogen eliminating apparatus and the channel switching portion in combination depending on the capacity of the hydrogen eliminating apparatus.

### Example 5

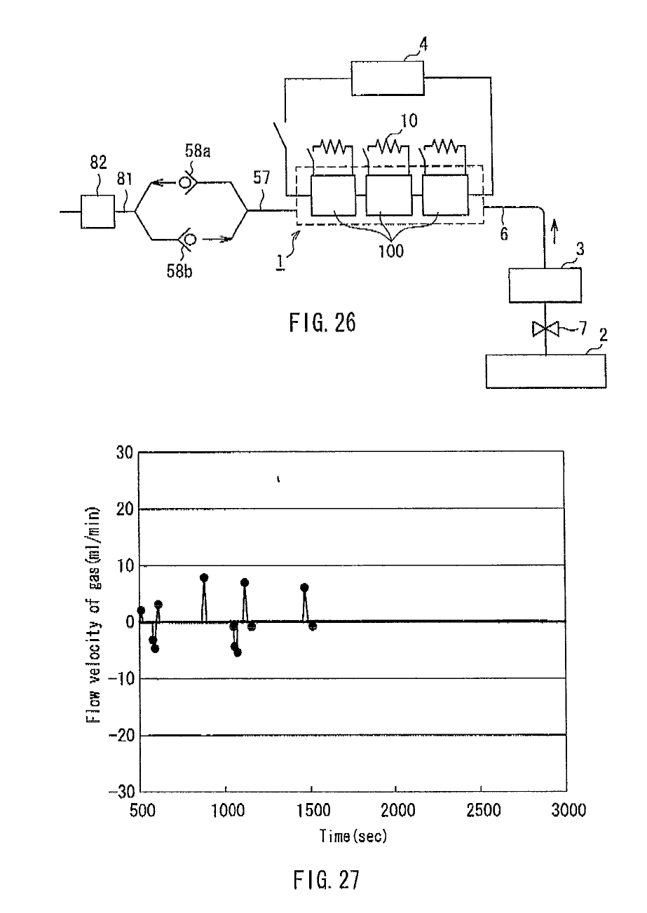

By providing the stop valve 7 between the hydrogen producing apparatus 2 and the hydrogen eliminating apparatus 3 and providing the fuel cell 1 with the backflow prevention portions 58a and 58b in the fuel cell, power generation system of Example 1, a fuel cell power generation system shown in FIG. 26 was configured. Check valves were used as the backflow prevention portions 58a and 58b. Ventilation paths connected respectively to one end of the backflow prevention portions 58a and 58b were merged with each other to form the ventilation path 57 and ventilation paths connected respectively to the other end of the backflow prevention portions 58a and 58b were merged with each other to form the ventilation path 81. Amass flowmeter 82 was connected to the ventilation path 81 to measure a flow velocity of gas that flowed in and out via the backflow prevention portions 58a and 58b. “Mass Flow MODEL 3660” manufactured by KOFLOC was used as the mass flowmeter 82.

<Power Generation Test>

A power generation test was conducted at 25° C. by using the fuel cell power generation system of Example 5. By using the water supply pump 36 of the hydrogen producing apparatus 2, the water 35a in the water containing vessel 35 was supplied to the hydrogen-generating-material containing vessel 34 to generate hydrogen, and the hydrogen was supplied to the fuel cell 1. By turning on the external load 4, the fuel cell 1 was operated at a constant voltage of 2.0 V, and power was generated for 4 hours. After 40 minutes had passed from the beginning of the power generation, a voltage value (A) of the MEA 100 located on the hydrogen producing apparatus 2 side in the fuel cell 1 and a voltage value (B) of the MEA 100 located on the ventilation path 57 side in the fuel cell 1 were started being measured, and they were kept measured for 200 seconds.

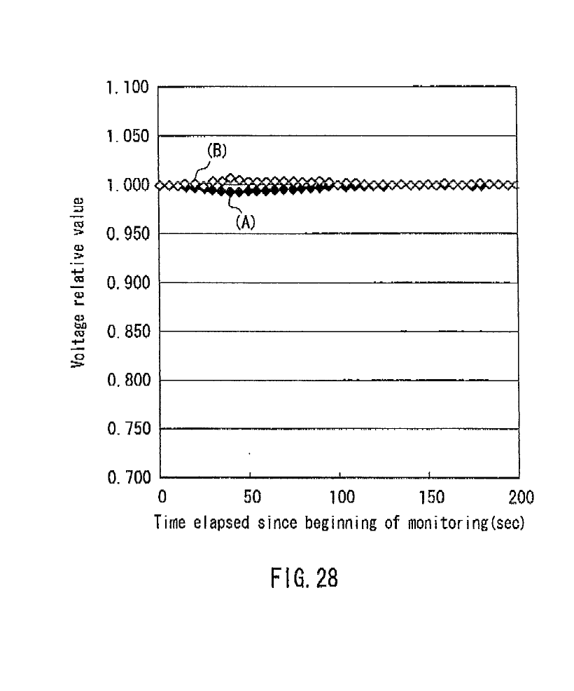

Further, after 500 seconds had passed from the beginning of the power generation, a flow velocity of gas that flowed in and out of the fuel cell 1 was measured, and it was kept measured until 3,000 seconds passed from the beginning of the power generation. FIG. 27 is a graph showing a change over time in the flow velocity of the gas that flowed in and out of the fuel cell 1. Further, FIG. 28 is a graph showing a change in the voltage value (A) of the MEA 100 located, on the hydrogen producing apparatus 2 side in the fuel cell 1 and a change in the voltage value (B) of the MEA 100 located on the ventilation path 57 side in the fuel cell 1. Each voltage value is shown relative to the value at the time when the monitoring started.

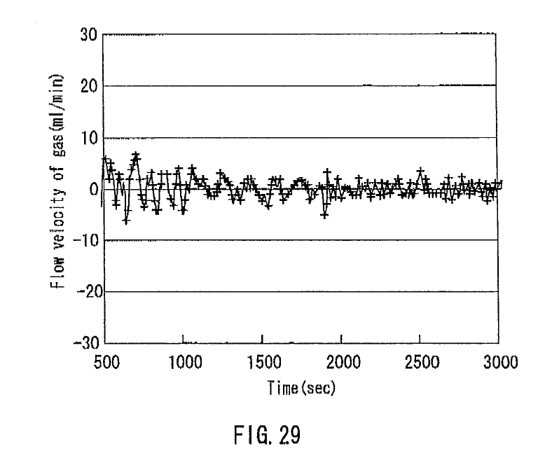

In the system of Example 5 provided with the check valves (the backflow prevention portions 58a and 58b), the flow velocity of the gas was stable as a whole as shown in FIG. 27. In contrast, when the pressure was fluctuated momentarily in a large amount, it can be seen that the fluctuations in the pressure were suppressed effectively by ventilating the gas by opening the valves. As a result, the fuel cell 1 was able to be operated stably as shown in FIG. 28. For the purpose of comparison, FIG. 29 shows a change over time in a flow velocity of gas in a fuel cell power generation system in which the backflow prevention portions 58a and 58b were not provided and the ventilation paths 57 and 81 were connected to each other directly. The flow velocity of the gas fluctuated significantly while being on the minus side as a whole, audit can be seen that the inner pressure of the fuel cell 1 was likely to fluctuate due to fluctuations in pressure of the hydrogen supplied to the fuel cell 1. Thus, an output of the fuel cell 1 was likely to be affected by the fluctuations in pressure of the hydrogen supplied to the fuel cell 1.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

In the fuel cell power generation system of the present invention, deterioration of the fuel cell due to the hydrogen at the time of the operation of the fuel cell being stopped can be prevented with a relatively simple structure. Thus, the system can be downsized easily. Therefore, the fuel cell power generation system of the present invention can be preferably used for a variety of applications including application as a power source for a high-performance portable electronic device in which a conventional fuel cell is used.

1. A fuel cell power generation system comprising:
a fuel cell including a first membrane electrode assembly including a positive electrode for reducing oxygen, a negative electrode for oxidizing hydrogen, and a solid electrolyte membrane disposed between the positive electrode and the negative electrode; and
a fuel channel for supplying hydrogen to the fuel cell,
wherein the fuel cell includes a plurality of the first membrane electrode assemblies, and
a hydrogen eliminating apparatus capable of eliminating at least part of the hydrogen that is present in the system is connected to the fuel channel.

2. The fuel cell power generation system according to claim 1, wherein the hydrogen eliminating apparatus includes a second membrane electrode assembly including a positive electrode for reducing oxygen, a negative electrode for oxidizing hydrogen, and a solid electrolyte membrane disposed between the positive electrode and the negative electrode.

3. The fuel cell power generation system according to claim 1, wherein a flow of hydrogen that is supplied to the fuel cell can be adjusted with the hydrogen eliminating apparatus when the fuel cell is in operation.

4. The fuel cell power generation system according to claim 1, wherein the positive electrode and the negative electrode of each of the first membrane electrode assemblies can be brought into electric conduction.

5. The fuel cell power generation system according to claim 2, wherein the positive electrode and the negative electrode of the second membrane electrode assembly can be brought into electric conduction.

6. The fuel cell power generation system according to claim 1, further comprising a channel switching portion capable of switching between inflow of hydrogen to the fuel cell and intake of outside air to the fuel cell,
wherein the channel switching portion is disposed in the fuel channel between the fuel cell and the hydrogen eliminating apparatus.

7. The fuel cell power generation system according to claim 1, further comprising a channel switching portion capable of switching between inflow of hydrogen to the fuel cell and intake of outside air to the fuel cell,
wherein the channel switching portion is disposed in the fuel channel between the fuel cell and the hydrogen eliminating portion, and
outside air is taken into the system by operating the channel switching portion after a voltage of at least one of the first membrane electrode assemblies drops to 1 V or less.

8. The fuel cell power generation system according to claim 1, further comprising a channel switching portion capable of switching between inflow of hydrogen to the fuel cell and intake of outside air to the fuel cell,
wherein the channel switching portion is disposed in the fuel channel between the fuel cell and the hydrogen eliminating portion, and
outside air is taken into the system by operating the channel switching portion when a voltage of all of the first membrane electrode assemblies is 0.2 V or more.

9. The fuel cell power generation system according to claim 1, further comprising a backflow prevention portion,
wherein the backflow prevention portion can let out surplus hydrogen in the fuel cell.

10. The fuel cell power generation system according to claim 1, further comprising a backflow prevention portion,
wherein the backflow prevention portion can take outside air into the fuel cell.

11. The fuel cell power generation system according to claim 1, further comprising a hydrogen source.

12. The fuel cell power generation system according to claim 11, wherein the hydrogen source is a hydrogen generating material that generates hydrogen by reacting with water.
